(19) United States
(12) Patent Application Publication
(10) Pub. No.: US 2026/0284830 A1
(43) Pub. Date: Sep. 24, 2026

(54) Method and System for Automated Surface Treatment

(71) Applicant: Palladyne Corp., Salt Lake City, UT (US)

(72) Inventors: Christopher R. Hirschi, Salt Lake City, UT (US); Fraser M. Smith, Salt Lake City, UT (US)

(21) Appl. No.: 19/574,171

(22) Filed: Mar. 20, 2026

Related U.S. Application Data
(60) Provisional application No. 63/775,068, filed on Mar. 20, 2025.

(51) Int. Cl. B24B 49/00; B24B 41/00; B24B 49/10; B24B 49/12; B24B 49/14; B25J 11/00; B64F 5/40

(52) U.S. Cl. CPC B24B 49/003; B24B 41/002; B24B 49/10; B24B 49/12; B24B 49/14; B25J 11/0065; B64F 5/40

(57) ABSTRACT

An example system for automating treatment of a working surface of a substrate can include a robotic arm and end of arm tooling operable with at least one surface treatment tool operable to remove material from the working surface. A first sensor can be operable to measure a force associated with the end of arm tooling as engaged with the working surface. A second sensor can be operable to directly measure a property of the working surface. A control module can be operable to detect the presence of the working surface, operate the end of arm tooling about the working surface as part of a surface treatment event comprising removing material from the working surface, determine a change in a working surface characteristic, and facilitate adjustment of operation of the end of arm tooling or robotic arm in response to the change in the working surface characteristic.

### RELATED APPLICATIONS

This application claims the benefit of U.S. Provisional Patent Application Serial No. 63/775,068, filed Mar. 20, 2026, entitled, “Method and System for Automated Surface Treatment,” which is incorporated by reference herein in its entirety.

### BACKGROUND

Various processes are used for removing material from surfaces, such as removing paint or other coatings. Paint coatings are often removed from vehicles or components of vehicles, such as cars, buses, trucks, aircraft, boats, train cars, and so on. Removal of paint coatings can be particularly useful in the aircraft industry because of the added weight introduced by paint. Even when paint is applied to aircraft in a thin layer, the paint can add a significant amount of weight to the aircraft. This can affect the performance of the aircraft and make flight less efficient. On the other hand, paint can be very beneficial for helping protect aircraft components from water damage and other environmental damage. Paint also helps maintain an attractive appearance of aircraft, which can be important especially for commercial aircraft. Therefore, paint continues to be applied to many aircraft despite the added weight introduced by the paint.

Aircraft are often painted using paint systems, where a system consists of at least a primer coat and a top coat. Additional paint systems may be applied from time to time when the previous paint becomes worn or when a different color or appearance is desired for the aircraft. However, each additional paint system can add additional weight to the aircraft. Therefore, the layers of paint and primer can be removed periodically to reduce the weight. After removing some or all of the paint and primer layers, the aircraft can then be repainted.

Processes for removing paint and primer layers from aircraft including chemical processes and abrasive processes. Chemical strippers can be used to dissolve or soften paint. The softened paint can then be scraped off more easily. However, chemical strippers can be harmful to workers, environmentally unfriendly, and expensive. Abrasive processes can involve using an abrasive medium to sand or grind the paint layer away. Some abrasive processes utilize particle blasting, in which abrasive particles such as plastic beads are blasted at the surface with pressurized air. Other abrasive processes utilize contact abrasive tools such as sanders or grinders. For example, a worker may use a sander to sand away one or more layers of paint or primer from an aircraft panel. The sanding can prepare the surface of the aircraft panel for repainting, such as be applying a new system of primer and paint.

### SUMMARY

An initial overview of the inventive concepts is provided below and then specific examples are described in further detail later. This initial summary is intended to aid readers in understanding the examples of the present technology more quickly, but is not intended to identify key features or essential features of the examples, nor is it intended to limit the scope of the present technology or the claimed subject matter.

In one example, the present technology sets forth a system for automating treatment of a working surface of a substrate. The system can include a robotic arm and end of arm tooling supported on the robotic arm. The end of arm tooling can be operable with at least one surface treatment tool operable to remove material from the working surface. The system can also include a first sensor operable to sense at least one aspect of, and to provide information associated with, a surface treatment event. The first sensor can be operable to measure a force associated with the end of arm tooling as engaged with the working surface. The system can also include a second sensor operable with the end of arm tooling, and operable to directly measure a property of the working surface. A control module can be operable to control the robotic arm and the end of arm tooling and the first and second sensors. The control module can include one or more processors operable with one or more memory devices. The control module can also include instructions that, when executed by the one or more processors, cause the control module to: detect the presence of the working surface, operate the end of arm tooling about the working surface as part of a surface treatment event comprising removing material from the working surface, determine a change in a working surface characteristic using information provided by at least one of the first or second sensors, and facilitate adjustment of the operation of at least one of the end of arm tooling or the robotic arm in response to the change in the working surface characteristic.

In another example, a method for automating the selective treatment of a working surface of a substrate can include identifying a working surface of a substrate for surface treatment. The nature of the surface treatment to be carried out on the substrate can be identified. A robotic system can be deployed to initiate a surface treatment event. The robotic system can include a robotic arm supporting end of arm tooling supporting at least one surface treatment tool operable to remove material from the working surface. The robotic system can also include a first sensor and a second sensor operable to sense at least one aspect of, and to provide information associated with a surface treatment event. Material can be removed from the working surface using the surface treatment tool. The method can further include measuring a force associated with the end of arm tooling as engaged with the working surface using the first sensor. A property of the working surface can be measured using the second sensor. Information can be provided associated with the surface treatment event using at least one of the first or second sensors. A change in a working surface characteristic can be determined using this information. The method can also include adjusting operation of at least one of the end of arm tooling or the robotic arm in response to the change in the working surface characteristic.

In another example, a system for automatic treatment of a working surface of a substrate can include a robotic arm and end of arm tooling supported on the robotic arm. The end of arm tooling can be operable with at least one surface treatment tool operable to remove material from the working surface. The system can include a sensor operable to sense at least one aspect of, and to provide information associated with, a surface treatment event. A control module can be operable with the robotic arm and the end of arm tooling and the sensor. The control module can include one or more processors operable with one or more memory devices. The control module can also include a machine learning module, and instructions that, when executed by the one or more processors, cause the control module to: detect the presence of the working surface, operate the end of arm tooling about the working surface as part of a surface treatment event comprising removing material from the working surface, input the information provided by the sensor into the machine learning module, using the machine learning module to facilitate determination of a change in a working surface characteristic using the information provided by the sensor, and facilitate adjustment of the operation of at least one of the end of arm tooling or the robotic arm in response to the change in the working surface characteristic.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 illustrates a schematic view of an example system for automating treatment of a working surface in accordance with an example of the present technology.

FIG. 2 illustrates a schematic view of another example system for automating treatment of a working surface in accordance with an example of the present technology.

FIG. 3 illustrates a schematic view of another example system for automating treatment of a working surface in accordance with an example of the present technology.

FIG. 4 illustrates a schematic view of an example system for automatic treatment of a working surface in accordance with an example of the present technology.

FIG. 5 is a flowchart illustrating an example method for automating the selective treatment of a working surface of a substrate in accordance with an example of the present technology.

Reference will now be made to the examples illustrated, and specific language will be used herein to describe the same. It will nevertheless be understood that no limitation of scope is thereby intended.

### DETAILED DESCRIPTION

The following detailed description of exemplary embodiments of the present technology refers to the accompanying drawings, which form a part hereof and in which are shown, by way of illustration, examples in which the present technology may be practiced. While these exemplary embodiments are described in sufficient detail to enable those skilled in the art to practice the present technology, it should be understood that other embodiments may be realized and that various changes to the present technology may be made without departing from the spirit and scope of the present technology. Thus, the following more detailed description of the embodiments of the present technology is not intended to limit the scope of the invention, as claimed, but is presented for purposes of illustration only to describe the features and characteristics of the present technology, and to sufficiently enable one skilled in the art to practice the invention.

### Description of Terms

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

The similar terms “surface treatment” or “treatment of a surface” or “treating a surface” refers to any engagement of the end of arm tooling with the working surface of a substrate (coated, not coated, partially coated) for the purpose of modifying the working surface in one or more ways by way of material removal. At least two different types of “treatment” carried out on a substrate surface are contemplated herein. First, surface treatment can refer to selective removal (removal as desired or needed), of at least some of one or more existing layers of the working surface. For example, the working surface can comprise one or more foreign materials previously applied to, built-up on, or otherwise existing on the substrate (e.g., one or more surface coatings), wherein at least a part of one or more layers is removed. Removal of foreign materials can be partial, such as when at least a part of the foreign materials are to remain, such as for a finishing, preparing the working surface for subsequent processes, or other purposes. Second, this term can also refer to selective removal of at least some of the material of the working surface for the purpose of preparing the working surface for one or more purposes, such as for finishing the working surface (e.g., achieving a final surface finish (e.g., aesthetic look, texture, and/or feel)), preparing the working surface for a subsequent manufacturing process (e.g., painting), or any other purpose. This term can further refer to both of these different types of surface treatments.

The similar terms “working surface” or “surface of a substrate” refers to the actual surface of the one or more inherent materials making up the substrate, or to one or more layers of one or more foreign materials present or existing on (i.e., coating, partially coating) the actual surface of the substrate, or to a combination of these.

The term “foreign materials” refers to any materials that are present on the actual surface of the substrate that are not part of the actual material make-up of the substrate. Foreign materials can include, but are not limited to, one or more layers of paint, laminates, adhesives, decals, corrosion, sealants, contaminants, debris, or any other material covering or coating at least some of the inherent or actual surface of the substrate). All or part of the substrate can comprise one or more layers of foreign materials.

### Examples of the Technology

The present technology involves systems and methods for automating treatment of a working surface. The surface treatments involved can include removing a coating or other layer of material from the working surface using a variety of tools. Certain aspects of the surface treatment can be automated, which can provide multiple advantages compared to surface treatments performed manually by human workers. The particular automated aspects are described in more detail below.

Some types of surface treatments can be quite complex, and as such these surface treatments have often been performed by skilled workers. The example of removing paint and primer layers from aircraft is described herein. This process can be complex because aircraft components may include multiple layers of paint and primer, the surface contours can be complex, and the number of layers may not be known to the worker. The thickness of the layers is also often unknown, and layer thickness can vary in different locations on an aircraft component. Furthermore, the desired surface treatment can vary and may involve removing only the top layer of paint, or removing all layers of paint and primer, or removing all layers except for a base layer, or removing some other number of layers. Workers often remove layers of paint and primer using a handheld tool such as a rotary sander or orbital sander. Workers may rely on experience to determine the optimal way of sanding to remove coating layers. In some cases, a worker can pay attention to the “feel” of the tool while sanding, which can provide cues about the surface being sanded. Workers can also utilize visual cues, including different colors of different layers of paint, to determine when the desired layers have been removed. Workers may also use their own sense of touch to physically feel the surface to gauge roughness and find areas that require more sanding.

Manual sanding in this way can necessitate experienced workers that know how to remove the desired layers of paint and primer and provide the desired surface treatment. The process can be time consuming in some cases. Results can also be highly dependent on the skill and experience of individual workers and therefore results can have high variability. The workers can also be exposed to dangerous conditions, including dust generated by sanding the paint and primer. It is also common for workers performing manual sanding to experience ergonomic injuries such as repetitive stress injuries in the shoulder, elbow, and wrist. These injuries may be caused by the worker applying pressure to the sander during sanding, especially when in awkward positions. The high levels if vibration experienced by the worker during sanding can also cause injuries, such as damage to blood vessels and nerves in the fingers and hands.

The systems and methods described herein can address these issues by automating certain aspects of the surface treatment process. The systems can include a robotic arm that can manipulate a surface treatment tool. For example, the robot arm can support a sander to be used to sand a surface such as an aircraft panel. The system can also include one or more sensors that can provide information about the working surface. A control module can control the robotic arm and the one or more sensors. The control module can be programmed to use information provided by the sensors to determine a change in a characteristic of the working surface, such as when a particular paint layer has been sanded off. The control module can then facilitate adjustment of the operation of the robot arm and/or the surface treatment tool in response to the change in the working surface characteristic.

The system can be set up to provide full automation in some cases, meaning that the system can perform a surface treatment task automatically without any human control. In other examples, the system can be set up for teleoperation, in which a human worker can control at least some aspects of the robot arm and the surface treatment tool from a remote location. This can be useful to keep the worker out of hazardous conditions and prevent repetitive stress injuries. In further examples, the system can be set up for a range of combinations of automation and teleoperation, in which some aspects of the surface treatment process are automated and other aspects are teleoperated by a worker. In some cases, the automated aspects of the surface treatment process can allow the surface treatment to be performed faster and with lower variability. Additionally, the system can include sensors that provide information that would not otherwise be available to a human worker performing the surface treatment manually. This can allow the surface treatment to be performed more efficiently and with higher precision.

The systems and methods described herein can be used to remove materials such as paint and primer coating layers as described above. Other types of coating materials can also be removed, such as ceramic coatings, powder coat coatings, metal coatings, and any other coating materials. Additionally, in some cases the systems and methods can be used to remove a portion of a substrate material without any coating. The removal of a portion of the substrate material can be done to impart a desired surface finish to the substrate, such as a surface texture or a smooth surface. The desired surface finish can also be a rough surface that is ready for painting in some cases.

The substrates that may be treated using the systems and methods can include any substrate material, with or without coating layers, where it is desired to remove a portion of material from the surface. Some example types of substrates include aircraft components, automotive components, watercraft components, or other vehicle components. A variety of other substrates can also be treated.

To further describe the present technology, example embodiments are now set forth and described with reference to the figures. These example embodiments are not intended to be limiting in any way. In one example, a system for automating treatment of a working surface of a substrate can include a robotic arm and end of arm tooling supported on the robotic arm, and operable with at least one surface treatment tool operable to remove material from the working surface. The system can also include a first sensor operable to sense at least one aspect of, and to provide information associated with, a surface treatment event. The first sensor can be operable to measure a force associated with the end of arm tooling as engaged with the working surface. The system can also include a second sensor operable with the end of arm tooling. The second sensor can be operable to directly measure a property of the working surface. A control module can be operable to control the robotic arm and the end of arm tooling and the first and second sensors. The control module can include one or more processors operable with one or more memory devices, and instructions that, when executed by the one or more processors, cause the control module to perform several steps. The steps can include detecting the presence of the working surface, operating the end of arm tooling about the working surface as part of a surface treatment event comprising removing material from the working surface, determining a change in a working surface characteristic using information provided by at least one of the first or second sensors, and facilitating adjustment of the operation of at least one of the end of arm tooling or the robotic arm in response to the change in the working surface characteristic.

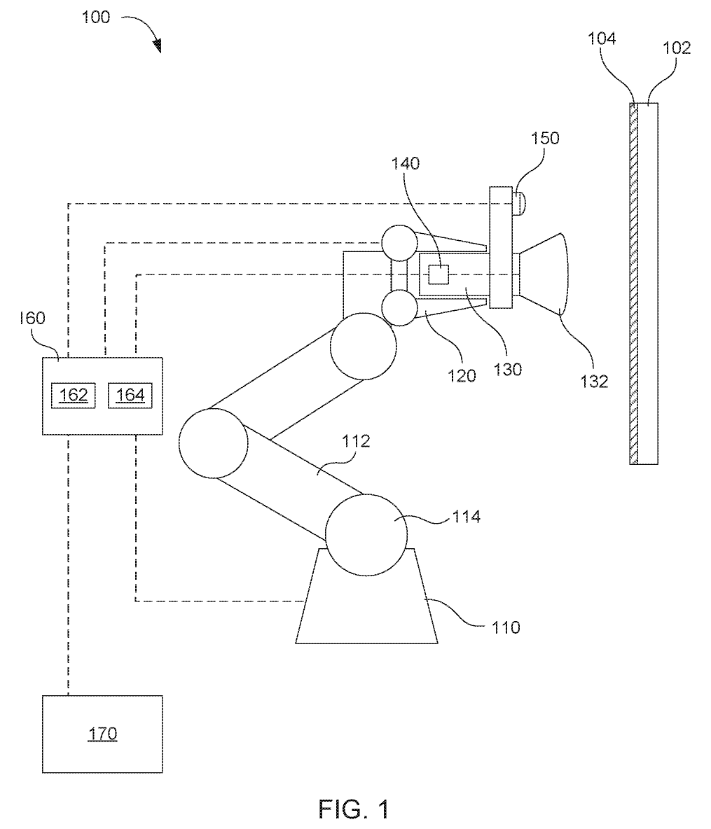

FIG. 1 shows a schematic side view of an example system 100 for automating treatment of a working surface. This example includes a robotic arm 110. In one example, the robotic arm can be made up of a plurality of arm segments 112 and joints 114 providing the robotic arm with multiple degrees of freedom. The robotic arm supports end of arm tooling 120, which in this example is a gripper that is operable to grasp a surface treatment tool 130. The surface treatment tool includes a sanding pad 132 that can be used to remove material from a working surface by sanding. The working surface in this example is a panel 102 having a coating 104 to be removed. The system also includes a first sensor 140. The first sensor is operable to measure a force associated with the end of arm tooling as engaged with the working surface. In this particular example, the first sensor is an electric current detector that can measure the electric current flowing to the electrically powered sanding motor of the surface treatment tool. When the sander is used to sand the working surface, the working surface can apply a force resisting the motion of the sanding pad. The stronger this force is, the more electric current will be consumed by the motor to maintain the same sanding pad speed. Thus, measuring the electric current to the motor is an indirect way to measure the force of resistance applied by the working surface to the sanding pad 132. This is one example of how a force can be measured by the first sensor 140. A variety of other examples are described below.

The system also includes a second sensor 150 that is operable to directly measure a property of the working surface. In this example, the second sensor 150 is an optical sensor can image the working surface. The optical sensor can be used to detect changes in color or other visible features of the working surface. The sensors 140, 150 and the robotic arm 110 and the end of arm tooling 120 are electronically connected (represented by dashed lines) to a control module 160. The control module includes a processor 162 and a memory device 164. The memory device can include instructions that, when executed by the processor, cause the control module to operate the end of arm tooling about the working surface as part of a surface treatment event comprising removing material from the working surface. In this example, the surface treatment event can be sanding the coating layer 104 off the panel 102. The instructions can also cause the control module 160 to determine a change in a working surface characteristic using information provided by at least one of the first or second sensors 140, 150. In this example, the change in the working surface characteristic can include the removal of the coating layer 104 on the panel 102. One example change can occur when the coating has been removed from a portion of the panel. Another example change can occur when the coating has been removed from the entire panel. The instructions can also cause the control module 160 to facilitate adjustment of the operation of at least one of the end of arm tooling or the robotic arm in response to the change in the working surface characteristic. In this example, this adjustment can include automatically moving the robotic arm so that the sanding pad sands a different area of the panel 102 after the coating 104 has been removed from one area. Another example adjustment can be stopping the sanding when the coating 104 has been fully removed from the entire panel 102. In various examples, the control module 160 can be programmed to perform these functions automatically, or the control module can provide information to a human worker that controls the system by teleoperation to signal to the human worker that the operation of the robotic arm 110 or the end of arm tooling 120 should be adjusted in response to the change in the working surface characteristic. The system includes a teleoperation terminal 170 electronically connected to the control module. The teleoperation terminal 170 can be at a safe, remote location where a human user can teleoperate the system.

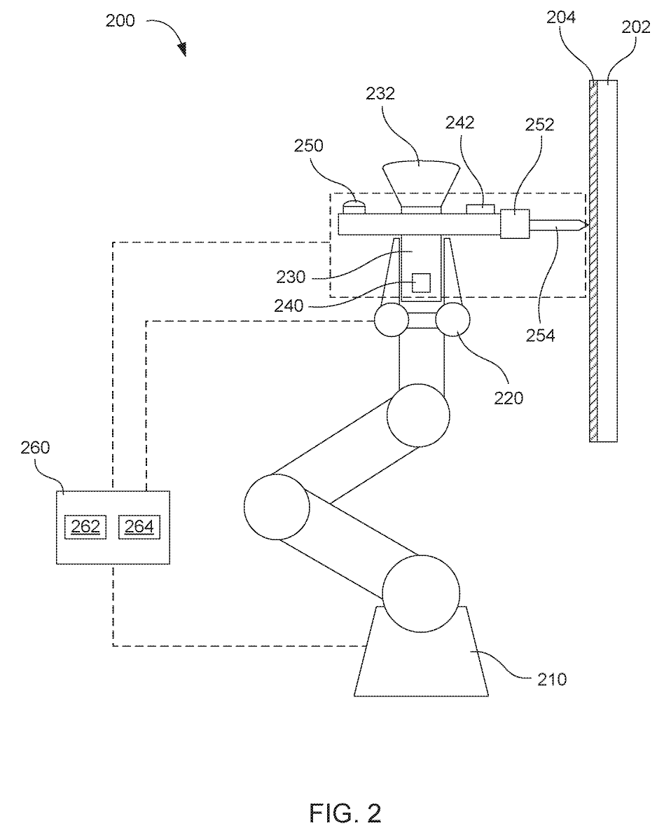

The system can include a variety of additional sensors. In some examples, a suite of sensors can be used to measure multiple different aspects of the working surface and the surface treatment process. Another example system 200 for automating treatment of a working surface of a substrate is shown in FIG. 2. This example system includes a suite 244 of sensors that includes a first sensor 240 and a second sensor 250 and two additional sensors 242, 252. In this example, the first sensor 240 is an electric current detector that measures electric current flowing to the electric motor of the surface treatment tool 230, as in the previous example. The second sensor 250 is optical sensor as in the previous example. A third sensor 242 is an acoustic sensor that detects sound produced by the sanding pad 232 sanding the working surface. A fourth sensor is a hardness sensor 252 that includes a non-destructive indenter 254 that can be placed in contact with the working surface and pressure can be applied to the indenter to measure the hardness of the working surface based on how much pressure is required to indent the surface. In this example the hardness sensor is mounted to the surface treatment tool 230. The end of arm tooling 220, which is a gripper in this example, can pivot the surface treatment tool so that the sanding pad is temporarily not in contact with the working surface and the indenter 254 of the hardness sensor 252 can be placed in contact with the working surface instead. In other examples, the hardness sensor can be positioned so that hardness testing can occur simultaneous with sanding. The other sensors can be used during sanding or while sanding is temporarily stopped. The system 200 also includes a robotic arm 210 as in the previous example, and a control module 260 that includes a processor 262 and a memory device 264. The working surface is a panel 202 with a coating layer 204 as in the previous example.

The systems described herein can have a robotic arm that is operable with end of arm tooling to support a surface treatment tool and to move the surface treatment tool over a working surface to perform a surface treatment on the working surface. The robotic arm can have one or more actuatable joints. In some examples, the robotic arm can have at least 2 degrees of freedom (2 DoF). In further examples, the robotic arm can have from 2 DoF to 7 DoF or more. Commercial robotic arms can be used, and the end of arm tooling of the robotic arms can be used to support the surface treatment tool. In certain examples, the commercial robotic arm can be a 3-axis robotic arm, or a 4-axis robotic arm, or a 5-axis robotic arm, or a 6-axis robotic arm, or a robotic arm with more axes. The robotic arm can be capable of moving a surface treatment tool to a working surface and moving the surface treatment tool across at least a portion of the area of the working surface in multiple degrees of freedom. Some working surfaces can be flat, while others can be curved or have corners or other irregular shapes. Therefore, the robotic arm can have sufficient degrees of freedom to move the surface treatment tool around the features of a particular working surface.

The end of arm tooling refers to an end effector supported by the robotic arm. In some examples, the end effector can be a gripper, claw, clamp, or other such end effector that can be used to pick up and grasp other objects. In particular, the end effector can be used to support a surface treatment tool. In other examples, the end of arm tooling can include an interface designed to attach to the surface treatment tool. In certain examples, the end of arm tooling can add additional degrees of freedom to the robotic arm. For example, the end of arm tooling can include one or more additional joints that allow for additional movement of the surface treatment tool. In certain examples, the end of arm tooling can be operable to tilt the surface treatment tool with respect to the working surface, or rotate the surface treatment tool, or move the surface treatment tool closer to the working surface or farther away from the working surface, or a combination of these. In further examples, the end of arm tooling can be operable to apply pressure to the surface treatment tool. This pressure can include normal force pressure pressing the surface treatment tool against the working surface, or changing a center of pressure where the surface treatment tool applies higher pressure using a specific portion of the surface treatment tool, or applying pressure to an edge of the surface treatment tool by tilting the surface treatment tool, or a combination of these.

Although the examples shown above include a sander as the surface treatment tool, the systems can include different types of surface treatment tools. In some examples, the surface treatment tool can be any type of tool that is operable to remove material from a surface. In certain examples, the surface treatment tool can include an abrasive machining tool, a cutting tool, a drilling tool, a milling tool, an etching tool, a laser machining tool, a buffing tool, a particle-blasting tool, an abrading tool, a polishing tool, or a combination of these. In further examples, the surface treatment tool can include a disc sander, an orbital sander, a random orbit sander, a belt sander, a drum sander, or an oscillating sander.

The various sensors described herein can be operable with the end of arm tooling to sense an aspect of a surface treatment event and provide information associated with the surface treatment event. The location of the sensors can vary depending on the type of sensor and the design of the system. In some examples, sensors can be mounted to the end of arm tooling, or integrated into the end of arm tooling, or gripped or otherwise supported by the end of arm tooling, or sensors can be located away from the end of arm tooling such as at a base of the robotic arm, or in a location in the facility containing the robotic arm, or integrated into the control module. In further examples, the sensors can be mounted to the surface treatment tool or integrated in the surface treatment tool. In certain examples, the end of arm tooling can include a support operable to support the surface treatment tool and one or more sensors. The sensors can be supported at or proximal to the surface treatment tool.

Sensors used in the systems described herein can be roughly divided into categories of direct sensors and indirect sensors. Direct sensors can include sensors that detect a property of the working surface itself, independent of the operation of the surface treatment tool. For example, direct sensors can be used to measure properties of the working surface even when the surface treatment tool is turned off, or even if the surface treatment tool were not present. Direct sensors can include sensors such as optical sensors that detect visible characteristics of the working surface, hardness sensors that measure the hardness of the working surface, roughness sensors that directly measure roughness of the working surface, electric conductivity sensors that measure electric conductivity of the working surface, ultrasonic sensors that utilize ultrasound to measure thickness of layers on the working surface, temperature sensors that measure the temperature of the working surface, and so on.

Indirect sensors can include sensors that sense a characteristic of the working surface indirectly through the interaction between the working surface and the surface treatment tool. For example, some force sensors can measure forces between the working surface and the surface treatment tool while the surface treatment tool is in operation. In another example, an acoustic sensor can detect sound produced when the surface treatment tool is running and in contact with the working surface. These indirect sensors can provide information that the control module can use to determine changes in characteristics of the working surface. For example, the forces present between the surface treatment tool and the working surface can be different depending on the condition of the working surface and the type of material present on the working surface. In certain examples, the forces can change when the surface treatment tool removes a coating layer and contacts another layer or a substrate material beneath the removed coating layer. Similarly, the sound produced by the surface treatment tool can be different depending on what type of material it being removed by the tool. The sound can change when the surface treatment tool removes a coating layer, and this change in sound can be detected by an acoustic sensor.

The direct and indirect sensors mentioned above can provide information to the control module, and the control module can use this information to determine when a certain change occurs in a characteristic of the working surface. The change in the working surface characteristic can be any change that is of interest and which may prompt an adjustment in the operation of the robotic arm or end of arm tooling. Adjusting the end of arm tooling can include adjusting the operation of the surface treatment tool and/or the sensors in the system. In some examples, the change in the working surface characteristic can be a transition from a first coating layer to a second coating layer when the surface treatment tool removes the fist coating layer. In other examples, the change can be the removal of all coating layers from a working surface, so that the bare substrate material is exposed. In still further examples, the change can be the transition from one coating layer to another coating layer after any desired number of coating layers has been removed from the working surface. On a more detailed level, the change in the working surface characteristic can be any change in any of the properties measured by the various sensors, such as a change in force exerted by the working surface on the surface treatment tool, or an acoustic change, or an optical change in the working surface, or a change in roughness, hardness, electric conductivity, ultrasonic response, temperature, and so on.

In more detail regarding force sensors, the system can include a first sensor that is operable to measure a force associated with the end of arm tooling as engaged with the working surface. When the surface treatment tool is placed in contact with the working surface, the surface treatment tool can apply a force to the working surface and the working surface can apply an equal and opposite force to the surface treatment tool, assuming that both are stationary. In some examples, this overall force can be measured, and can be interchangeably described as the force exerted by the tool on the working surface, or as the force exerted by the working surface on the tool. However, the surface treatment tool can also be in motion during operation of the system. The force exerted by the working surface on the surface treatment can affect the motion of the tool in some cases. Therefore, the motion of the tool can also be measured in order to more accurately determine the force exerted by the working surface on the tool.

The overall force exerted by the working surface on the surface treatment tool can be broken down into component vectors, including a normal force component and a component orthogonal to the normal force component. The orthogonal component can be parallel to the working surface in some cases or parallel to an abrasive surface of the surface treatment tool in some cases, depending on the shape of the working surface and the shape of the tool. The normal force component can be caused by pressure applied to the tool by the robotic arm and end of arm tooling. Therefore, the normal force usually is dependent only on the operation of the robotic arm and end of arm tooling, and the normal force does not provide any information about the condition of the working surface. However, the orthogonal force component can vary depending on conditions of the working surface. For example, different surface materials can apply different forces to the surface treatment tool as the surface treatment tool removes material. In an example where the surface treatment tool is a sander, there may be some materials that are easier to sand or harder to sand. Some materials can be sanded away more quickly, while others take longer to sand away. Some materials have more friction between the material and the sander. These factors can affect the force applied by the working surface on the sander. In particular, the differences in force can be detected in the force component that is orthogonal to the normal force vector. In other words, the forces of interest are in the direction opposing the motion of the sanding pad. As the sanding pad moves across the working surface, the working surface applies a force to the sanding pad in the opposite direction of the motion of the sanding pad.

The particular forces of interest can depend on the particular type of surface treatment tool used. In one example, the surface treatment tool can be a rotary sander. The rotary sander can include a circular sanding pad that spins powered by an electric motor. When the spinning sanding pad is in contact with the working surface, the working surface applies a force to each part of the sanding pad in the opposite direction to the motion of that part of the sanding pad. As a result, the force applied by the working surface to the sanding pad manifests as a torque in the opposite direction to the rotation of the sanding pad. The torque can be indirectly measured by measuring a parameter of the rotary sander that is affected by the torque. For example, if the power of the rotary sander is constant, then the rotation speed of the sanding pad will be reduced by the torque. In this cases, the torque can be measured by detecting the change in rotation speed of the sanding pad (i.e., the difference between the expected rotational speed of the sanding pad without the working surface and the actual rotation speed of the sanding pad). In another example, the rotation speed of the sanding pad can be constant, and the torque exerted by the working surface can cause the rotary sander to consume more power. In the case of an electric rotary sander, the power can be measured by measuring electric current flowing to the motor of the sander while the voltage is constant. If the rotary sander is powered pneumatically, then the pneumatic power can be measured by measuring a differential pressure of the pneumatic pressurized air across the sander motor (i.e., the air pressure entering the pneumatic motor of the sander vs. the pressure of air exiting the motor) or a flow rate of pressurized air through the sander motor. In further examples, it can be possible to directly measure the torque using a strain gauge, pressure transducer, or similar sensor placed to measure force between the surface treatment tool and the end of arm tooling or the robotic arm. The torque can tend to make the surface treatment tool twist in the direction of the torque, but the end of arm tooling can hold the surface treatment tool and prevent the twisting motion. However, a strain gauge or pressure transducer or similar force sensor can be incorporated into the end of arm tooling or into the surface treatment tool to measure this force. In addition to rotary sanders, a variety of other surface treatment tools can have rotating components and the force of the working surface applied to the surface treatment tool can be a torque opposing the rotation. With any such surface treatment tools, the torque can be measured in a similar way.

In another example, the surface treatment tool can be an orbital sander or random orbital sander. These types of sanders move the sanding pad with a more complex motion than simple rotation. Therefore, the forces exerted by the working surface on the sanding pad, which oppose the motion of the sanding pad, can be many different directions. However, these sanders also use a motor that spins to drive the motion of the sanding pad. Therefore, measuring electric current to the motor or pneumatic pressure drop or pneumatic air flow rate across the motor can be used with these sanders, similar to the rotary sanders. Although the direction of the force may be complex and varied, the overall magnitude of the force applied by the working surface can be related to the power consumed by the motor.

In further examples, the surface treatment tool can apply force to the working surface in one direction. As one example, the surface treatment tool can be a belt sander that includes a sanding belt that moves linearly in one direction. Therefore, the force applied by the working surface to resist the motion of the sanding belt is always in the same direction, opposite to the motion of the sanding belt. Drum sanders and oscillating sanders can also be used, and may apply a force primarily in one direction. In this example, the power consumed by the motor can also be measured as in the previous examples. This can be accomplished by measuring electric current or pneumatic pressure drop or pneumatic flow rate as in the previous examples. Additionally, the speed of the belt can be measured to provide an indirect measure of the force. Since the force in this example is always in one direction, the force can be directly measured using a strain gauge, pressure transducer, or similar force sensor that can be integrated into the surface treatment tool, or the end of arm tooling, or the robotic arm.

In more detail regarding measuring electric current to an electric motor in the surface treatment tool, in some examples this can be accomplished using an ammeter. An ammeter can be included in the electric motor or coupled to the electric motor to monitor electric current used by the electric motor. In further examples, periodic or continuous measurements can be taken to monitor the electric current.

It is noted that the system can include one of the types of force sensors described above, or a combination of multiple types of force sensors. Using multiple different force sensors can provide more information to the control module, which can allow the control module to determine the forces more accurately and to make more accurate determinations about changes in the working surface.

Force sensors can also be used to detect vibrational forces. Vibrations can be caused by the operation of the surface treatment tool when engaged with the working surface. In various examples, the force sensor can be used to measure a magnitude of a vibrational force, a frequency of a vibrational force, a direction of a vibrational force, or a combination thereof.

The system can also include an additional friction sensor operable to directly measure friction of the working surface. The friction sensor can include a shear sensor that measures the force used to slide an object over the working surface. The friction sensor can include a friction element that contacts the working surface, such as a roller, scraper, or other device that can slide across the working surface to measure the force of friction.

Sensors that can be included also include an electric conductivity sensor. An electric conductivity sensor can include two or more electrodes that can contact the working surface to measure electric conductivity of the working surface between the electrodes. The electric conductivity can be affected by the type of material at the working surface, the thickness of the coating present on the working surface, or a combination of these. Therefore, the electric conductivity sensor can provide useful information about the material present on the working surface. In some examples, the electrodes can be configured to be in continuous contact with the working surface while the surface treatment tool is operated. In other examples, the electrodes can be contacted to the working surface while the surface treatment tool has stopped temporarily. It is noted that the electric conductivity can also be referred to as an electric conductance sensor or electric resistance sensor. Any of these measurements can provide information about the material on the working surface.

An optical sensor can be used to measure optical characteristics of the working surface. In some examples, the optical sensor can measure color including hue, brightness, and saturation. Differences in these measured values can in some cases be due to difference in coating materials or differences due to the surface finish. The optical sensor can include a camera positioned to image the working surface. In further examples, the optical sensor can include a spectrometer to measure intensity of specific wavelengths. The optical sensor can be configured to measure visible light, infrared (IR) radiation, ultraviolet (UV) radiation, or a combination of these. In certain examples, the optical sensor can include an illuminator that can illuminate the working surface with light to assist in capturing optical measurements. The illuminator can be configured to provide light of known wavelengths or a known spectrum of wavelengths. The illuminator can also be useful to measure specularity and/or reflectivity. Differences in these properties can also provide information about different materials or different surface finishes present on the working surface.

Images captured by an optical camera (including visible, IR, UV, or a combination of these) can be processed by a computer vision module operable with control module in some examples. The computer vision module can identify various features of the working surface using the images. The features can include variations in color, variations in specularity or reflectivity, imperfections in coating layers, edges of the working surface substrate. The computer vision module can also detect changes over time in the working surface, and information associated with these changes can be provided to the control module so that the control module can use this information to determine a change in a working surface characteristic.

In further examples, the system can include a hardness sensor. Different coating materials can have different hardness. Therefore, hardness measurements can help identify coating materials and determine when one coating has been removed. The hardness measurements can also be relevant for operation of the surface treatment tool. For example, the optimal normal pressure applied to the surface treatment tool and the optimal speed at which the surface treatment tool operates may be different when treating materials of different hardness. Thus, the control module can utilize information about the hardness of the material on the working surface both for determining changes in working surface characteristics and also for adjusting the operation of the robotic arm, end of arm tooling, and the surfacing treatment tool. In certain examples, the hardness sensor can be configured to measure hardness using non-destructive scratch (Mohs scale test, etc.), indentation (e.g., Rockwell, Vickers, Shore, Brinell, etc.), and/or rebound (e.g., Leeb rebound, etc.) methods. In certain examples, a spring loaded or otherwise actuated probe can be positioned to contact the working surface and apply a sufficient force to measure the force using any suitable force sensor, such as a strain gauge, pressure transducer, or others. The force to indent the surface can then be measured. In some examples, the hardness measurement can be non-destructive so that the working surface is not damaged by the hardness sensor.

A roughness sensor can also be included. In some examples, roughness can be measured by a profilometer that includes stylus that contacts the working surface. The stylus can be dragged across the surface to measure deviations in the surface height to measure the average roughness of the surface. The roughness measurements can provide information about the material on the working surface and the surface finish present on the working surface.

Another type of sensor that can be used is an acoustic tap sensor. A tapping device can be configured to tap the working surface once per measurement or periodically to induce a measurable acoustic tap response. One or more microphones can be positioned to detect an acoustic tap response. Alternatively, a vibration on the working surface as a result of a tap can be measured. The tap response can be affected by the type of material at the working surface and the thickness of the coating layer at the working surface.

An ultrasonic sensor can also be included. This can include any type of ultrasonic sensor having an ultrasonic emitter and receiver. Ultrasonic sensors can be used to find and visualize features below a surface based on reflection of ultrasound waves. The ultrasonic sensor can be placed in contact with the working surface in some examples, and a receiver can measure the ultrasonic response. In some examples, this can provide information about the type of material and thickness of coating layers on the working surface.

A temperature sensor can also be used to measure the temperature of the working surface. The temperature sensor can be a contact temperature sensor or non-contact temperature sensor. Although temperature may not provide useful information about the working surface when used on its own, the temperature measurements can be combined with information about the speed and pressure applied with the surface treatment tool to provide information about how the surface treatment tool affected the temperature of the working surface. Additionally, temperature measurements can be taken in multiple different locations on the working surface and differences in the temperature can provided information about differences between these different areas of the working surface.

The system can also include sensors that are not utilized for determining changes in characteristics of the working surface, but which are used for other purposes to assist in operation of the system. For example, distance sensors can be used to help orient the surface treatment tool with respect to the working surface. Ultrasonic distance sensors can be used in some examples, which can send pulsed ultrasound waves toward the working surface and measure to distance to the working surface based on the time taken for reflected sound to return to the sensor. In certain examples, multiple distance sensors can be arranged about the surface treatment tool to help keep the tool oriented parallel to the working surface. The distance sensors can be integrated into the surface treatment tool, or mounted on the surface treatment tool, or integrated into the end of arm tooling, or mounted on the end of arm tooling in some examples.

The system can also include a clogging or filling sensor. As used herein, “clogging” and “filling” can be used interchangeably to refer to the phenomenon of material that has been removed from the working surface becoming stuck to or lodged in the surface treatment tool. In particular, the abrasive element of an abrasive surface treatment tool, such as a sanding pad or grinding head, can become clogged over time as particles of material fill the spaces between abrasive particles on the abrasive tool head. This clogging can reduce the efficacy of the tool over time. In some examples, the system can include a sensor that can detect clogging by various methods. In one example, the clogging sensor can include an optical sensor such as a camera that can image the surface treatment tool and the clogging level of the tool can be determined from the images. Clogging sensors can also include a mass sensor operable to detect a change in mass dur to clogging in the surface treatment tool. In another example, the clogging can be measured indirectly by detecting a change in the forces associated with the surface treatment tool engaged with the working surface. In certain examples, a clogged abrasive tool can result in increased friction between the abrasive tool and the working surface, but reduced efficacy of material removal from the working surface. This can result in slow progress on removing material from the working surface while generating more heat. Therefore, clogging can be detected by detecting a change in temperature that is more than expected with a clean abrasive tool head, or by detecting an increase in the force of friction together with a decreases in efficacy of material removal. A clogged surface treatment tool may also generate a different sound when operating. Thus, a clogging sensor can include an acoustic sensor that can detect this change in sound. Additionally, a clogging or fill rate model can be prepared for a particular type of abrasive media, such as a sanding pad or grinding head. The fill rate model can be used to predict how long it will take to fill or clog the abrasive media, and also what change in friction force and heat generation is expected with various amounts of clogging.

Wear can also be an issue over time for some surface treatment tools. Therefore, the system can include a wear sensor in some examples. The wear sensor can include an optical sensor that can image the surface treatment tool and then the control module can determine a level of wear based on the images. In certain examples, the optical sensor can be a microscopic camera that can be used to examine the surface treatment tool. Wear can also be detected by detecting reduced efficacy of removing material from the working surface and/or by increased friction. A wear rate model can be used to predict the wear over time of a particular surface treatment tool, similar to the fill rate models mentioned above. Wear sensors can also include a mass sensor operable to detect a change in mass due to wear. A temperature sensor or an acoustic sensor can also be used, similar to the clogging sensors described above.

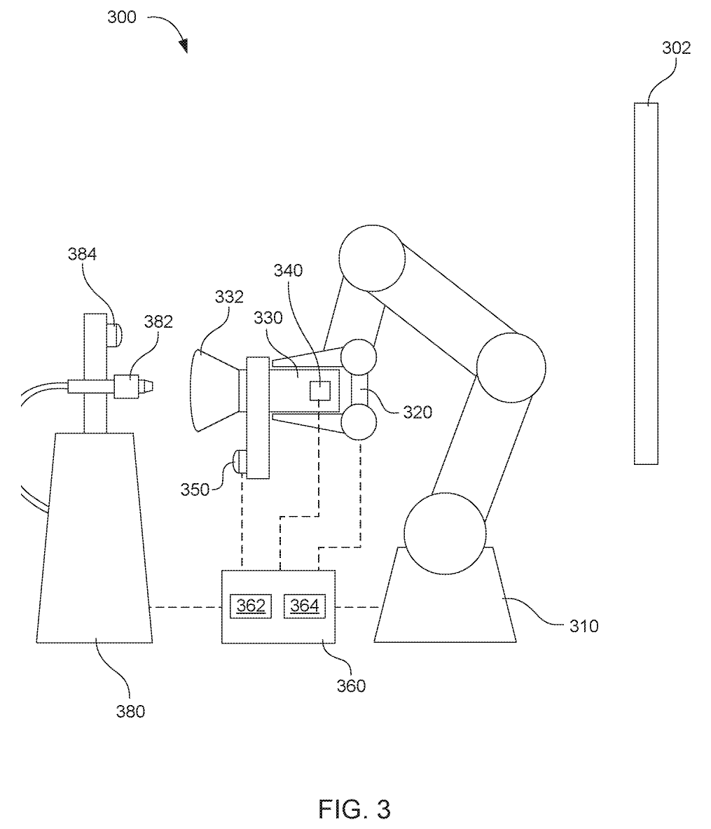

In further examples, the system can include a mechanism to renew the surface treatment tool. FIG. 3 shows an example system 300 for automating treatment of a working surface that includes a renewal station 380. The renewal station can be positioned near the robotic arm 310, such as on the opposite side of the robotic arm from the working surface 302. The renewal station in this example includes an air blower 382 that can blow pressurized air on the surface treatment tool 330. The surface treatment tool in this example includes a sanding pad 332 which can be clogged with material over time. The control module 360 can be programmed with a fill rate model for the abrasive media of the sanding pad 332, and the control module can use the model to determine periodically to renew the sanding pad. To renew the sanding pad 332, the control module can cause the robotic arm 310 to move the sanding pad next to the air blower 382 as shown in this figure. The air blower can then used pressurized air to blow the clogging material off the sanding pad. The renewal station also includes a clogging sensor 384, which in this example is an optical sensor. The clogging sensor 384 can be used to image the sanding pad 332 before blowing the pressurized air, after blowing the pressurized air, or at other times to determine a clogging level of the sanding pad based on the images. As in previous examples, the control module includes a processor 362 and a memory device 364 that can include instructions to perform these functions. Additionally, the surface treatment tool 330 is held by end of arm tooling 320 on the robotic arm. A first sensor 340 and a second sensor 350 are also included as in previous examples.

Different types of abrasive media can clog at different rates. Sandpaper is a common type of abrasive media that tends to clog quickly. Therefore, sandpaper can require renewing more often. Some abrasive media clogs less quickly, such as nonwoven abrasive fabric, abrasive screens, and others. In certain examples, the surface treatment tool can include a nonwoven abrasive fabric or an abrasive screen as the abrasive media.

The control module can be programmed to operate in an automated mode in some examples. In the automated mode, the control module can be programmed to make substantially all decisions regarding the operation of the robotic arm, end of arm tooling, surface treatment tool, sensors, and any other components of the system. In certain examples, parameters for a particular surface treatment operation can be pre-programmed in the control module. For example, a human worker can pre-program a sanding path for sanding a particular aircraft component. The human worker may also pre-program a final goal of the operation, such as sanding off all paint layers except for a base coat layer. With these instructions, the control module can be programmed to carry out the sanding operation without further human input in automated mode. The control module can use various sensors as described above to determine changes in the working surface characteristics as the sanding operation progresses. These changes can include determining when the sander has sanded through coating layers and which portions of the surface have reaches which coating layers. The control module can adjust the operation of the robotic arm, end of arm tooling, and surface treatment tool in response to these changes. For example, the control module can cause the robotic arm to move the surface treatment tool from an area where the desired coating layer has been removed to another area where the coating layer still needs to be removed. In the automated working mode, the control module can facilitate automated operation of high level and low level aspects of operation of the robotic arm and the end of arm tooling.

The control module can also operate in a teleoperated working mode. In the teleoperated working mode, the control module can facilitate teleoperation of a high level aspect of operation of the robotic arm, or the end of arm tooling, or both. At the same time, the control module can facilitate automation of a low level aspect of the operation of the robotic arm, or the end of arm tooling, or both. In this mode, a human worker can provide commands to the control module by teleoperation for some of the functions of the system. The human can make decisions for high level aspects of the system operation. Some high level aspects can include gross movements of the robotic arm, deciding what area of the working surface to treat with the surface treatment tool, and so on. Some low level aspects can include maintaining the surface treatment tool parallel with the working surface, maintaining an appropriate pressure on the surface treatment tool, recording measurements using the various sensors of the system, and determining changes in a working surface characteristic based on information from the sensors. In some cases, the control module can also augment the human worker’s teleoperation by providing information to the human user. The information can include measurements taken using sensors and/or determinations of changes in the working surface. For example, the control module can provide an electronic display to the human worker showing areas where certain coating layers have been removed, or the control module can display the predicted thickness of coating layers in one or more locations on the working surface, or the control module can display material types of materials on the working surface that were determined using sensor measurements.

The control module can also operate in an augmented teleoperated mode. In this mode, the control module can facilitate teleoperation of high level and low level aspects of operation of the robotic arm and end of arm tooling. Thus, the human worker can control high level and low level operation of the system. For example, the human worker can make decisions about the orientation of the surface treatment tool, the amount pressure applied to the surface treatment tool, the gross movements of the robotic arm, and various other decisions. The control module can also provide information to the human user in this mode. In particular, the control module can determine changes in working surface characteristics using the sensors and then the control module can provide information associated with the changes in working surface characteristics to the human user. The control module can also provide a signal to the human user when the surface treatment tool needs to be renewed. The human user can then control the robotic arm to renew the surface treatment tool.

In at least the automated working mode, and in some examples the teleoperated working mode, the control module can facilitate application of pressure to the surface treatment tool and consequently the pressure of the tool on the working surface. In certain examples, the control module can be programmed to make subtle adjustments to the tilt or angle of the surface treatment tool to adjust the pressure applied to the working surface, or the center of pressure of the area where the tool is applied to the working surface. For example, when the surface treatment tool includes a sanding pad, the sanding pad can be tilted slightly to move the center of pressure of the sanding pad closer to an edge of the sanding pad. This can concentrate the pressure in a smaller area, causing the sanding pad to sand a smaller area of the working surface. If sufficient tilt is used then the center of pressure can move to the edge of the sanding pad, so that the sanding pad only removes material in a small area at the edge of the sanding pad. concentrating the pressure and sanding in this way can also increase the rate of sanding in the smaller sanding area. It is noted that with rotary sanders, the outer edge of the sanding pad moves at a faster speed than the inner area of the sanding pad. In some examples, the control module can be programmed to account for this by slowing the rotation of the sanding pad when the center of pressure moves to the edge of sanding pad. The control module can dynamically determine an appropriate speed and change the speed of the sanding pad depending on the center of pressure considered together with sensor measurements and any other relevant data.

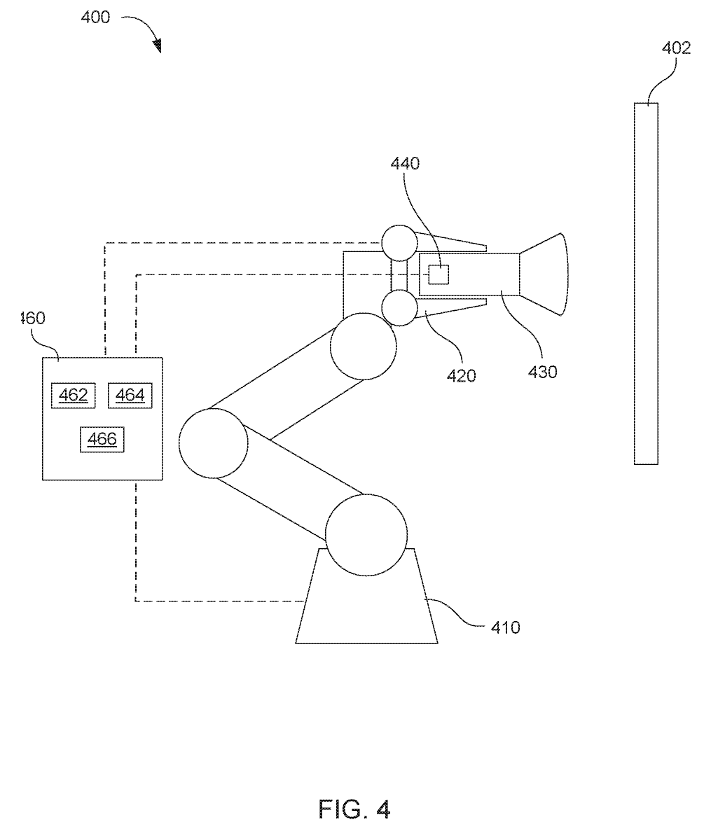

In further examples, the control module can include a machine learning module. For example, FIG. 4 shows another example system 400 for automatic treatment of a working surface. This system includes a robotic arm 410 with end of arm tooling 420 supported on the robotic arm as in previous examples. The end of arm tooling is operable with a surface treatment tool 430 that is operable to remove material from the working surface 402 as in previous examples. In this particular system, only a single sensor 440 is included. In this case, the sensor is a force sensor that measures the electric current flowing to the surface treatment tool motor. The system also includes a control module 460 that includes a processor 462, a memory device 464, and a machine learning module 466. The control module can include instructions that, when executed by the processor, cause the control module to detect the presence of the working surface, operate the end of arm tooling about the working surface as part of a surface treatment event comprising removing material from the working surface, input the information provided by the sensor into the machine learning module, facilitate determination of a change in a working surface characteristic using the machine learning module with the information provided by the sensor, and facilitate adjustment of the operation of the end of arm tooling or the robotic arm, or both, in response to the change in the working surface characteristic.

The machine learning module can be trained using a set of inputs. Various inputs can be helpful for training the machine learning module. In some examples, information provided by the sensors of the system can be included in the inputs. Sensor measurements collected during the current surface treatment operation can be input into the machine learning module. Additionally, sensor measurements from previous surface treatment operations can be input into the machine learning module. The machine learning module can form connections between various sensor measurements that may effect each other, sometimes in ways that may not be clear to human users. In the example of FIG. 4, the system includes only a single sensor. However, in other examples, the system can include multiple sensors or a suite of sensors, including any combination of the sensors described herein. The inputs to the machine learning module can include measurement data from all of these sensors.

The training inputs for the machine learning module can also include example operations performed by a human user. In certain examples, the human user can operate the robotic arm, or the end of arm tooling, or both using teleoperation. The movements and other operations performed by the human user can be input as an example to the machine learning module. In effect, the human user can demonstrate the correct way to perform a surface treatment operation. Sensor measurement data collected during the example teleoperation can also be input into the machine learning module.

Any information that is known about the system can also be input into the machine learning model. Such inputs can include an identification of the material of the working surface, an identification of a coating material on the working surface, an identification of an abrasive medium on the surface treatment tool, an initial condition of the working surface provided by a sensor or multiple sensors, or combinations of these. As explained above, the system can include various sensors for detecting characteristics of the working surface. In some examples, before beginning to use the surface treatment tool to perform a surface treating operation, one or more sensors can be used to measure various characteristics of the initial working surface. These measurements can include any measurements possible with the sensors described herein, such as temperature measurements of the working surface, temperature measurements of the surface treatment tool, hardness measurements of the working surface, electric conductance measurements of the working surface, ultrasound measurements of the working surface, roughness measurements of the working surface, optical measurements of the working surface, friction measurements of the working surface, and so on. The machine learning module can utilize these initial condition measurements along with other training data to help the machine learning module facilitate determination of changes in working surface characteristics.

Initial condition data can also be collected by performing a test operation, such as by treating a small portion of the working surface first and recording sensor measurements. The recorded data can then be utilized by the machine learning module when performing the surface treatment operation on the remainder of the working surface. In one example, a sanding operation can begin with initially sanding a small portion of the working surface. This initial sanding can be performed more carefully and slowly than usual in order to collect useful data and avoid unwanted damage to the working surface, such as by over-sanding. Sensor data can be measured during the initial sanding to learn information about the working surface, such as number of layers of different coatings, the thickness of the coatings, properties of the coating materials, and so on. Once these data have been learned, the machine learning module can utilize these data to perform the sanding operation on the remainder of the working surface more quickly and accurately.

In further examples, the machine learning module can also be used to facilitate the adjustment of the operation of the end of arm tooling, or the robotic arm, or both. Adjustment of the end of arm tooling can include adjustment of the surface treatment tool and sensors that are associated with the end of arm tooling. With sufficient training data, the machine learning module can be used to provide decisions associated with operating the system, such as where to move the robotic arm, how much pressure to apply to the surface treatment tool, how fast to run the surface treatment tool, and so on. Any functions of the control module described herein can be facilitated using the machine learning module. Utilizing the machine learning module can help the control module make decisions based on connections between variables, where the connections have been formed by the machine learning module. As explained above, machine learning modules can often discover connections between variables that are unknown to human users. Therefore, utilizing the machine learning module can sometimes provide better decisions than if the control module were limited to following pre-programmed functions.

The machine learning module can also include a library of legacy information that can help the machine learning module discover connections that ware useful in performing a surface treatment operation. The library can include information such as properties of the working surface, properties of other known surfaces, sensor measurements of the working surface measured by the sensors present in the system, sensor measurements previously measured for other surfaces, sensor measurements recorded by sensors of other systems, known properties of the end of arm tooling, known properties of the surface treatment tool, known properties of the abrasive medium on the surface treatment tool, or combinations thereof. Any other data associated with the system and the working surface can be included in the library because such data can potentially be useful to the machine learning module.

A library of information can be generated by performing similar surface treatment processes multiple times. For example, to generate a library that is relevant for sanding aircraft components, a number of aircraft components can be sanded and sensor data can be recording during these sanding operations. The sensor data can be stored in the library. In certain examples, these sanding operations can be performed by a human user through teleoperation. In other examples, the machine learning module can be used to facilitate these sanding operations. Thus, the machine learning module can participate in building the library of legacy information that can be used in future operations.

In another example, a library of legacy information relevant to sanding automotive components can be created by performing a number of sanding operations on various automotive components. In one example, automotive components can be provided from a junkyard or other source and the components can be sanded without fear of damaging the components. Sensor data can be recorded during these sanding operations and used to create the library. The resulting library can be useful to a machine learning module that is used to facilitate the sanding of automotive components. In further examples, a library can be most relevant for surface treatment processes that are similar to the surface treatment processes used in creating the library. Therefore, library information can be collected through performing similar surface treatment processes multiple times.

In various examples, the machine learning module can be trained by inputting any combination of the following inputs: a library of legacy information; properties of the working surface; properties of other known surfaces; sensor measurements of the working surface; sensor measurements previously measured for other surfaces; sensor measurements recorded by sensors of other systems; known properties of the end of arm tooling; known properties of the surface treatment tool; known properties of the abrasive medium on the surface treatment tool; example teleoperation by a human user; an identification of a material of the working surface; an identification of a coating material on the working surface; an identification of an abrasive medium on the surface treatment tool; and an initial condition of the working surface provided by a sensor. In a particular example, the machine learning module can determine how long an abrasive media can be used reliably before renewing or replacing the media. In certain examples, a fill rate model for the abrasive media can be input into the machine learning module. In other examples, the machine learning module can determine a fill rate model from sensor data and legacy library information.

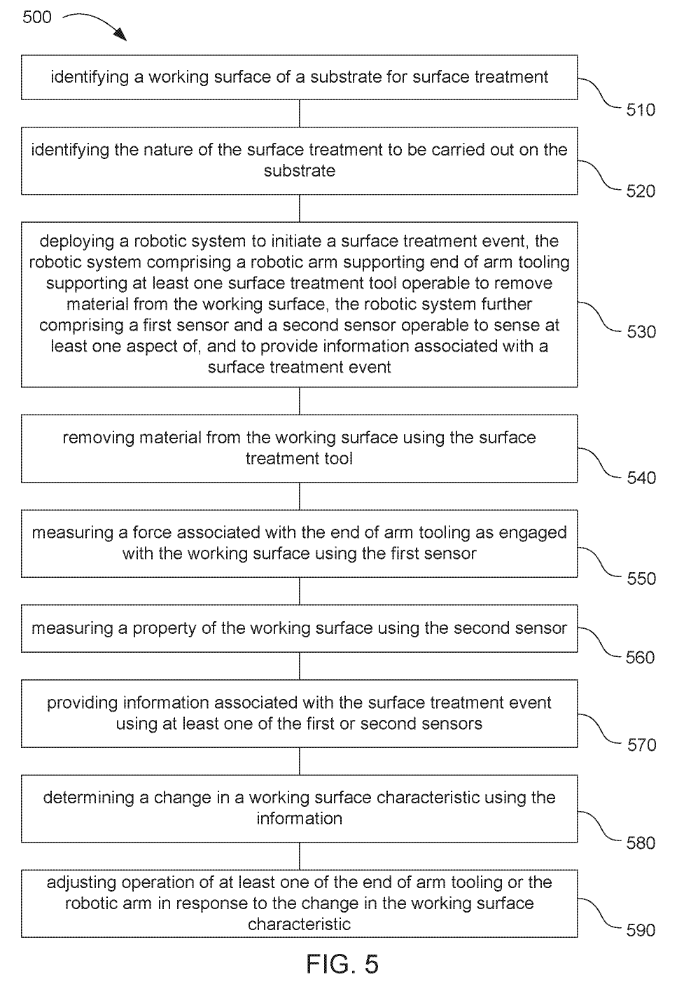

The present disclosure also describes methods of automating surface treatments. FIG. 5 is a flowchart illustrating one example method for automating the selective treatment of a working surface of a substrate 500. This method includes: identifying a working surface of a substrate for surface treatment 510; identifying the nature of the surface treatment to be carried out on the substrate 520; deploying a robotic system to initiate a surface treatment event, the robotic system comprising a robotic arm supporting end of arm tooling supporting at least one surface treatment tool operable to remove material from the working surface, the robotic system further comprising a first sensor and a second sensor operable to sense at least one aspect of, and to provide information associated with a surface treatment event 530; removing material from the working surface using the surface treatment tool 540; measuring a force associated with the end of arm tooling as engaged with the working surface using the first sensor 550; measuring a property of the working surface using the second sensor 560; providing information associated with the surface treatment event using at least one of the first or second sensors 570; determining a change in a working surface characteristic using the information 580; and adjusting operation of at least one of the end of arm tooling or the robotic arm in response to the change in the working surface characteristic 590. In further examples, methods can include any of the operations and functions described herein with respect to the systems.

### Examples

1. An example system for automating treatment of a working surface of a substrate, comprising

a robotic arm;

end of arm tooling supported on the robotic arm, and operable with at least one surface treatment tool operable to remove material from the working surface;

a first sensor operable to sense at least one aspect of, and to provide information associated with, a surface treatment event, the first sensor being operable to measure a force associated with the end of arm tooling as engaged with the working surface;

a second sensor operable with the end of arm tooling, and operable to directly measure a property of the working surface; and

a control module operable to control the robotic arm and the end of arm tooling and the first and second sensors, the control module comprising one or more processors operable with one or more memory devices, and instructions that, when executed by the one or more processors, cause the control module to:

detect the presence of the working surface,

operate the end of arm tooling about the working surface as part of a surface treatment event comprising removing material from the working surface,

determine a change in a working surface characteristic using information provided by at least one of the first or second sensors, and

2. The system of any of examples 1-29 or 67-72 or the method of any of examples 30-66, further comprising a third sensor operable to sense an operational state of one or more components of the end of arm tooling.

3. The system of any of examples 1-29 or 67-72 or the method of any of examples 30-66, further comprising a third sensor operable to sense an operational state of the at least one surface treatment tool.

4. The system of any of examples 1-29 or 67-72 or the method of any of examples 30-66, wherein the force comprises a normal force exerted on the surface treatment tool by the working surface, a rotational force exerted on the surface treatment tool by the working surface, a torque exerted on the surface treatment tool by the working surface, a force parallel to the working surface exerted on the surface treatment tool by the working surface, a force of friction exerted on the surface treatment tool by the working surface, or a combination thereof.

5. The system of any of examples 1-29 or 67-72 or the method of any of examples 30-66, wherein the force comprises a vibrational force, and wherein the first sensor is operable to measure a magnitude of the vibrational force, a frequency of the vibrational force, a direction of the vibrational force, or a combination thereof.

6. The system of any of examples 1-29 or 67-72 or the method of any of examples 30-66, wherein the force is indirectly measured by measuring one or more of electrical current passing through the surface treatment tool, a movement speed of the surface treatment tool, a pneumatic pressure head at the surface treatment tool wherein the surface treatment tool is pneumatic, a pneumatic flow through the surface treatment tool wherein the surface treatment tool is pneumatic, a temperature of the surface treatment tool, or a combination thereof.

7. The system of any of examples 1-29 or 67-72 or the method of any of examples 30-66, wherein the surface treatment tool comprises at least one of an abrasive machining tool, a cutting tool, a drilling tool, a milling tool, an etching tool, a laser machining tool, a buffing tool, a particle-blasting tool, an abrading tool, a polishing tool, or a combination thereof.

8. The system of any of examples 1-29 or 67-72 or the method of any of examples 30-66, wherein the surface treatment tool comprises a disc sander, an orbital sander, a random orbit sander, a belt sander, a drum sander, or an oscillating sander.

9. The system of any of examples 1-29 or 67-72 or the method of any of examples 30-66, wherein the surface treatment tool comprises a moving abrasive head, and wherein the first sensor is operable to measure a movement speed of the abrasive head.

10. The system of any of examples 1-29 or 67-72 or the method of any of examples 30-66, wherein, within an automated working mode, the control module facilitates automated operation of high level and low level aspects of operation of the robotic arm and the end of arm tooling.

11. The system of any of examples 1-29 or 67-72 or the method of any of examples 30-66, wherein, within a teleoperated working mode, the control module facilitates teleoperation of a high level aspect of operation of at least one of the robotic arm or the end of arm tooling while facilitating automation of a low level aspect of the operation of at least one of the robotic arm or the end of arm tooling.

12. The system of any of examples 1-29 or 67-72 or the method of any of examples 30-66, wherein, within an augmented teleoperated mode, the control module facilitates teleoperation of high level and low level aspects of operation of the robotic arm and the end of arm tooling, wherein the control module provides information associated with the change in the working surface characteristic to a human user.

13. The system of any of examples 1-29 or 67-72 or the method of any of examples 30-66, wherein the second sensor comprises an imaging device operable to optically image the working surface to detect a property of the working surface.

14. The system of any of examples 1-29 or 67-72 or the method of any of examples 30-66, wherein the imaging device is operable to distinguish wavelengths in the visible spectrum, the infrared spectrum, the ultraviolet spectrum, or a combination thereof.

15. The system of any of examples 1-29 or 67-72 or the method of any of examples 30-66, wherein the second sensor comprises a temperature sensor, a hardness sensor, a roughness sensor, an electric conductivity sensor, an ultrasonic sensor, or a combination thereof.

16. The system of any of examples 1-29 or 67-72 or the method of any of examples 30-66, further comprising an acoustic sensor operable to measure sound produced by operation of the surface treatment tool.

17. The system of any of examples 1-29 or 67-72 or the method of any of examples 30-66, wherein the first and second sensors are part of a suite of sensors.

18. The system of any of examples 1-29 or 67-72 or the method of any of examples 30-66, further comprising a clogging sensor operable to measure clogging of the surface treatment tool, or a wear sensor operable to measure wear of the surface treatment tool.

19. The system of any of examples 1-29 or 67-72 or the method of any of examples 30-66, wherein the clogging sensor comprises an optical sensor operable to detect an optical change due to clogging in the surface treatment tool, a mass sensor operable to detect a change in mass due to clogging in the surface treatment tool, a temperature sensor operable to detect a change in temperature due to clogging in the surface treatment tool, an acoustic sensor operable to detect a change in sound due to clogging in the surface treatment tool, a force sensor operable to detect a change in a force associated with the surface treatment tool, or a combination thereof.

20. The system of any of examples 1-29 or 67-72 or the method of any of examples 30-66, wherein the wear sensor comprises an optical sensor operable to detect an optical change due to wear in the surface treatment tool, a mass sensor operable to detect a change in mass due to wear in the surface treatment tool, a temperature sensor operable to detect a change in temperature due to wear in the surface treatment tool, an acoustic sensor operable to detect a change in sound due to wear in the surface treatment tool, a force sensor operable to detect a change in a force associated with the surface treatment tool, or a combination thereof.

21. The system of any of examples 1-29 or 67-72 or the method of any of examples 30-66, wherein the instructions further cause the control module to signal a need for renewal of the surface treatment tool when clogging or wear reaches a predetermined threshold.

22. The system of any of examples 1-29 or 67-72 or the method of any of examples 30-66, wherein the change in the working surface characteristic comprises a change in hardness, a change in roughness, a change in color, a change in infrared reflectivity, a change in ultraviolet reflectivity, a change in electric conductivity, a change in ultrasonic response, a change in a force associated with the end of arm tooling as engaged with the working surface, a change in sound produced by operation of the surface treatment tool, or a combination thereof.

23. The system of any of examples 1-29 or 67-72 or the method of any of examples 30-66, wherein the working surface comprises at least one coating layer, and wherein the change in the working surface characteristic occurs when at least a portion of the at least one coating layer has been removed to expose a lower layer.

24. The system of any of examples 1-29 or 67-72 or the method of any of examples 30-66, wherein adjusting the operation of the end of arm tooling comprises stopping the operation of the surface treatment tool, changing a speed of the surface treatment tool, changing a pressure of the surface treatment tool applied to the working surface, changing a center of pressure of the surface treatment tool on the working surface, changing an orientation of the surface treatment tool, or a combination thereof.

25. The system of any of examples 1-29 or 67-72 or the method of any of examples 30-66, wherein adjusting the operation of the robotic arm comprises stopping the operation of the robotic arm, changing a speed of movement of the robotic arm, moving the robotic arm to lift the surface treatment tool off the working surface, moving the robotic arm to treat a different area of the working surface with the surface treatment tool, moving the robotic arm to change a pressure of the surface treatment tool applied to the working surface, moving the robotic arm to change a center of pressure of the surface treatment tool on the working surface, moving the robotic arm to change an orientation of the surface treatment tool, or a combination thereof.

26. The system of any of examples 1-29 or 67-72 or the method of any of examples 30-66, wherein the control module comprises a machine learning module facilitating determination of the change in the working surface characteristic and adjustment of the operation of at least one of the end of arm tooling or the robotic arm, wherein the machine learning module is trained using a set of inputs comprising the information provided by at least one of the first or second sensors.

27. The system of any of examples 1-29 or 67-72 or the method of any of examples 30-66, wherein the set of inputs further comprises example teleoperation of at least one of the end of arm tooling or the robotic arm by a human user.

28. The system of any of examples 1-29 or 67-72 or the method of any of examples 30-66, wherein the set of inputs further comprises an identification of a material of the working surface, an identification of a coating material on the working surface, an identification of an abrasive medium on the surface treatment tool, an initial condition of the working surface provided by at least one of the first or second sensors, or a combination thereof.

29. The system of any of examples 1-29 or 67-72 or the method of any of examples 30-66, wherein the machine learning module further comprises a library of legacy information comprising properties of the working surface, properties of other known surfaces, sensor measurements measured by at least one of the first or second sensors from the working surface, sensor measurements previously measured by at least one of the first or second sensors of other surfaces, sensor measurements recorded by a sensor of another system, properties of the end of arm tooling, properties of the surface treatment tool, properties of an abrasive medium on the surface treatment tool, or a combination thereof.

30. An example method for automating the selective treatment of a working surface of a substrate, the method comprising:

identifying a working surface of a substrate for surface treatment;

identifying the nature of the surface treatment to be carried out on the substrate;

deploying a robotic system to initiate a surface treatment event, the robotic system comprising a robotic arm supporting end of arm tooling supporting at least one surface treatment tool operable to remove material from the working surface, the robotic system further comprising a first sensor and a second sensor operable to sense at least one aspect of, and to provide information associated with a surface treatment event;

removing material from the working surface using the surface treatment tool;

measuring a force associated with the end of arm tooling as engaged with the working surface using the first sensor;

measuring a property of the working surface using the second sensor;

providing information associated with the surface treatment event using at least one of the first or second sensors;

determining a change in a working surface characteristic using the information; and

31. The system of any of examples 1-29 or 67-72 or the method of any of examples 30-66, wherein the step of identifying the type of surface treatment to be carried out on the substrate comprises identifying the material to be removed from the working surface of the substrate.

32. The system of any of examples 1-29 or 67-72 or the method of any of examples 30-66, wherein the material to be removed comprises one or more coating layers on the working surface.

33. The system of any of examples 1-29 or 67-72 or the method of any of examples 30-66, wherein the one or more coating layers comprise paint, primer, powder coat, ceramic, metal, or a combination thereof.

34. The system of any of examples 1-29 or 67-72 or the method of any of examples 30-66, wherein the step of identifying the type of surface treatment to be carried out on the substrate comprises identifying a desired surface texture.

35. The system of any of examples 1-29 or 67-72 or the method of any of examples 30-66, wherein the desired surface texture is a rough surface prepared for painting.

36. The system of any of examples 1-29 or 67-72 or the method of any of examples 30-66, wherein the desired surface texture is a smooth surface finish.

37. The system of any of examples 1-29 or 67-72 or the method of any of examples 30-66, wherein the substrate comprises an aircraft component, an automotive component, or a watercraft component.

38. The system of any of examples 1-29 or 67-72 or the method of any of examples 30-66, wherein the robotic system further comprises an additional sensor operable to sense an operational state of one or more components of the end of arm tooling, and wherein the method further comprises measuring an operational state of one or more components of the end of arm tooling using the additional sensor.

39. The system of any of examples 1-29 or 67-72 or the method of any of examples 30-66, wherein the robotic system further comprises an additional sensor operable to sense an operational state of the at least one surface treatment tool, and wherein the method further comprises measuring an operational state of the at least one surface treatment tool.

40. The system of any of examples 1-29 or 67-72 or the method of any of examples 30-66, wherein the force comprises a normal force exerted on the surface treatment tool by the working surface, a rotational force exerted on the surface treatment tool by the working surface, a torque exerted on the surface treatment tool by the working surface, a force parallel to the working surface exerted on the surface treatment tool by the working surface, a force of friction exerted on the surface treatment tool by the working surface, or a combination thereof.

41. The system of any of examples 1-29 or 67-72 or the method of any of examples 30-66, wherein the force measured by the force sensor comprises a vibrational force, and wherein the first sensor is operable to measure a magnitude of the vibrational force, a frequency of the vibrational force, a direction of the vibrational force, or a combination thereof.

42. The system of any of examples 1-29 or 67-72 or the method of any of examples 30-66, wherein the force is measured indirectly by measuring one or more of electrical current passing through the surface treatment tool, a movement speed of the surface treatment tool, a pneumatic pressure head at the surface treatment tool wherein the surface treatment tool is pneumatic, a pneumatic flow through the surface treatment tool wherein the surface treatment tool is pneumatic, a temperature of the surface treatment tool, or a combination thereof.

43. The system of any of examples 1-29 or 67-72 or the method of any of examples 30-66, wherein the surface treatment tool comprises at least one of an abrasive machining tool, a cutting tool, a drilling tool, a milling tool, an etching tool, a laser machining tool, a buffing tool, a particle-blasting tool, an abrading tool, a polishing tool, or a combination thereof.

44. The system of any of examples 1-29 or 67-72 or the method of any of examples 30-66, wherein the surface treatment tool comprises a disc sander, an orbital sander, a random orbit sander, a belt sander, a drum sander, or an oscillating sander.

45. The system of any of examples 1-29 or 67-72 or the method of any of examples 30-66, wherein the surface treatment tool comprises a moving abrasive head, and wherein the first sensor is operable to measure a movement speed of the abrasive head.

46. The system of any of examples 1-29 or 67-72 or the method of any of examples 30-66, wherein the robotic system further comprises a control module operable to control the robotic arm and the end of arm tooling and the sensing fiduciary, the control module comprising at least one processor operable with one or more memory devices, and instructions that, when executed by the one or more processors, cause the control module to facilitate adjustment of operation of at least one of the end of arm tooling or the robotic arm in response to the change in the working surface characteristic.

47. The system of any of examples 1-29 or 67-72 or the method of any of examples 30-66, wherein, within an automated working mode, the control module facilitates automated operation of high level and low level aspects of operation the robotic arm and the end of arm tooling.

48. The system of any of examples 1-29 or 67-72 or the method of any of examples 30-66, wherein, within a teleoperated working mode, the control module facilitates teleoperation of a high level aspect of operation of at least one of the robotic arm or the end of arm tooling while facilitating automation of a low level aspect of the operation of at least one of the robotic arm or the end of arm tooling.

49. The system of any of examples 1-29 or 67-72 or the method of any of examples 30-66, wherein, within an augmented teleoperated mode, the control module facilitates teleoperation of high level and low level aspects of operation of the robotic arm and the end of arm tooling, wherein the control module provides information associated with the change in the working surface characteristic to a human user.

50. The system of any of examples 1-29 or 67-72 or the method of any of examples 30-66, wherein the second sensor comprises an imaging device operable to optically image the working surface, and wherein the property measured by the surface property sensor is an optical property.

51. The system of any of examples 1-29 or 67-72 or the method of any of examples 30-66, wherein the imaging device is operable to distinguish wavelengths in the visible spectrum, the infrared spectrum, the ultraviolet spectrum, or a combination thereof.

52. The system of any of examples 1-29 or 67-72 or the method of any of examples 30-66, wherein the second sensor comprises a temperature sensor, a hardness sensor, a roughness sensor, an electric conductivity sensor, an ultrasonic sensor, or a combination thereof.

53. The system of any of examples 1-29 or 67-72 or the method of any of examples 30-66, wherein the robotic system further comprises an acoustic sensor operable to measure sound produced by operation of the surface treatment tool, and wherein the method further comprises measuring the sound produced by operation of the surface treatment tool using the acoustic sensor.

54. The system of any of examples 1-29 or 67-72 or the method of any of examples 30-66, wherein the robotic system comprises a suite of sensors.

55. The system of any of examples 1-29 or 67-72 or the method of any of examples 30-66, wherein the robotic system further comprises a clogging sensor operable to measure clogging of the surface treatment tool, or a wear sensor operable to measure wear of the surface treatment tool.

56. The system of any of examples 1-29 or 67-72 or the method of any of examples 30-66, wherein the clogging sensor comprises an optical sensor operable to detect an optical change due to clogging in the surface treatment tool, a mass sensor operable to detect a change in mass due to clogging in the surface treatment tool, a temperature sensor operable to detect a change in temperature due to clogging in the surface treatment tool, an acoustic sensor operable to detect a change in sound due to clogging in the surface treatment tool, a force sensor operable to detect a change in a force associated with the surface treatment tool, or a combination thereof.

57. The system of any of examples 1-29 or 67-72 or the method of any of examples 30-66, wherein the wear sensor comprises an optical sensor operable to detect an optical change due to wear in the surface treatment tool, a mass sensor operable to detect a change in mass due to wear in the surface treatment tool, a temperature sensor operable to detect a change in temperature due to wear in the surface treatment tool, an acoustic sensor operable to detect a change in sound due to wear in the surface treatment tool, a force sensor operable to detect a change in a force associated with the surface treatment tool, or a combination thereof.

58. The system of any of examples 1-29 or 67-72 or the method of any of examples 30-66, further comprising signaling a need for renewal of the surface treatment tool when clogging or wear reaches a predetermined threshold.

59. The system of any of examples 1-29 or 67-72 or the method of any of examples 30-66, wherein the change in the working surface characteristic comprises a change in hardness, a change in roughness, a change in color, a change in infrared reflectivity, a change in ultraviolet reflectivity, a change in electric conductivity, a change in ultrasonic response, a change in a force between the end of arm tooling and the working surface, a change in sound produced by operation of the end of arm tooling, or a combination thereof.

60. The system of any of examples 1-29 or 67-72 or the method of any of examples 30-66, wherein the working surface comprises at least one coating layer, and wherein the change in the working surface characteristic occurs when at least a portion of the at least one coating layer has been removed to expose a lower layer.

61. The system of any of examples 1-29 or 67-72 or the method of any of examples 30-66, wherein adjusting the operation of the end of arm tooling comprises stopping the operation of the surface treatment tool, changing a speed of the surface treatment tool, changing a pressure of the surface treatment tool applied to the working surface, changing a center of pressure of the surface treatment tool on the working surface, changing an orientation of the surface treatment tool, or a combination thereof.

62. The system of any of examples 1-29 or 67-72 or the method of any of examples 30-66, wherein adjusting the operation of the robotic arm comprises stopping the operation of the robotic arm, changing a speed of movement of the robotic arm, moving the robotic arm to lift the surface treatment tool off the working surface, moving the robotic arm to treat a different area of the working surface with the surface treatment tool, moving the robotic arm to change a pressure of the surface treatment tool applied to the working surface, moving the robotic arm to change a center of pressure of the surface treatment tool on the working surface, moving the robotic arm to change an orientation of the surface treatment tool, or a combination thereof.

63. The system of any of examples 1-29 or 67-72 or the method of any of examples 30-66, further comprising using a machine learning module to facilitate determination of the change in the working surface characteristic and adjustment of the operation of the end of arm tooling or the robotic arm, wherein the machine learning module is trained using a set of inputs comprising the information provided by at least one of the first or second sensors.

64. The system of any of examples 1-29 or 67-72 or the method of any of examples 30-66, wherein the set of inputs further comprises example teleoperation of at least one of the end of arm tooling or the robotic arm by a human user.

65. The system of any of examples 1-29 or 67-72 or the method of any of examples 30-66, wherein the set of inputs further comprises an identification of a material of the working surface, an identification of a coating material on the working surface, an identification of an abrasive medium on the surface treatment tool, an initial condition of the working surface provided by at least one of the first or second sensors, or a combination thereof.

66. The system of any of examples 1-29 or 67-72 or the method of any of examples 30-66, wherein the machine learning module further comprises a library of legacy information comprising properties of the working surface, properties of other known surfaces, sensor measurements measured by at least one of the first or second sensors from the working surface, sensor measurements previously measured by at least one of the first or second sensors of other surfaces, sensor measurements recorded by a sensor of another system, properties of the end of arm tooling, properties of the surface treatment tool, properties of an abrasive medium on the surface treatment tool, or a combination thereof.

67. An example system for automatic treatment of a working surface of a substrate, comprising:

a robotic arm;

end of arm tooling supported on the robotic arm, and operable with at least one surface treatment tool operable to remove material from the working surface;

a sensor operable to sense at least one aspect of, and to provide information associated with, a surface treatment event;

a control module operable to control the robotic arm and the end of arm tooling and the sensor, the control module comprising one or more processors operable with one or more memory devices, the control module further comprising a machine learning module, and instructions that, when executed by the one or more processors, cause the control module to:

detect the presence of the working surface,

operate the end of arm tooling about the working surface as part of a surface treatment event comprising removing material from the working surface,

input the information provided by the sensor into the machine learning module,

using the machine learning module, facilitate determination of a change in a working surface characteristic using the information provided by the sensor, and

68. The system of any of examples 1-29 or 67-72 or the method of any of examples 30-66, wherein the machine learning module is trained using a set of inputs comprising the information provided by the sensor.

69. The system of any of examples 1-29 or 67-72 or the method of any of examples 30-66, wherein the sensor is part of a suite of sensors and wherein the set of inputs further comprises information provided by the suite of sensors.

70. The system of any of examples 1-29 or 67-72 or the method of any of examples 30-66, wherein the set of inputs further comprises example teleoperation of at least one of the end of arm tooling or the robotic arm by a human user.

71. The system of any of examples 1-29 or 67-72 or the method of any of examples 30-66, wherein the set of inputs further comprises an identification of a material of the working surface, an identification of a coating material on the working surface, an identification of an abrasive medium on the surface treatment tool, an initial condition of the working surface provided by the sensor, or a combination thereof.

72. The system of any of examples 1-29 or 67-72 or the method of any of examples 30-66, wherein the machine learning module further comprises a library of legacy information comprising properties of the working surface, properties of other known surfaces, sensor measurements measured by the sensor from the working surface, sensor measurements previously measured by the sensor of other surfaces, sensor measurements recorded by a sensor of another system, properties of the end of arm tooling, properties of the surface treatment tool, properties of an abrasive medium on the surface treatment tool, or a combination thereof.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Although the disclosure may not expressly disclose that some embodiments or features or examples described herein may be combined with other embodiments or features or examples described herein, this disclosure should be read to describe any such combinations that would be practicable by one of ordinary skill in the art. Indeed, the above detailed description of embodiments of the present technology are not intended to be exhaustive or to limit the present technology to the precise form disclosed above. Although specific embodiments of, and examples for, the present technology are described above for illustrative purposes, various equivalent modifications are possible within the scope of the present technology as those skilled in the relevant art will recognize. For example, although steps are presented in a given order, alternative embodiments can perform steps in a different order. The various embodiments described herein can also be combined to provide further embodiments.

Furthermore, the described features, structures, characteristics or examples of the present technology may be combined in any suitable manner in one or more examples. In the preceding description, numerous specific details were provided, such as examples of various configurations to provide a thorough understanding of examples of the described technology. It will be recognized, however, that the present technology may be practiced without one or more of the specific details, or with other methods, components, devices, etc. In other instances, well-known structures or operations are not shown or described in detail to avoid obscuring aspects of the technology.

Moreover, unless the word “or” is expressly limited to mean only a single item exclusive from other items in reference to a list of two or more items, then the use of “or” in such a list is to be interpreted as including (a) any single item in the list, (b) all of the items in the list, or (c) any combination of the items in the list. In other words, the use of “or” in this disclosure should be understood to mean non-exclusive “or” (i.e., “and/or”) unless otherwise indicated herein.

Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications can be made without deviating from the technology. Further, while advantages associated with some embodiments of the present technology have been described in the context of those embodiments, other embodiments can also exhibit such advantages, and not all embodiments need necessarily exhibit such advantages to fall within the scope of the technology. Accordingly, the disclosure and associated present technology can encompass other embodiments not expressly shown or described herein.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described present technology.

What is claimed is:

1. A system for automating treatment of a working surface of a substrate, comprising
a robotic arm;
end of arm tooling supported on the robotic arm, and operable with at least one surface treatment tool operable to remove material from the working surface;
a first sensor operable to sense at least one aspect of, and to provide information associated with, a surface treatment event, the first sensor being operable to measure a force associated with the end of arm tooling as engaged with the working surface;
a second sensor operable with the end of arm tooling, and operable to directly measure a property of the working surface; and
a control module operable to control the robotic arm and the end of arm tooling and the first and second sensors, the control module comprising one or more processors operable with one or more memory devices, and instructions that, when executed by the one or more processors, cause the control module to:
detect the presence of the working surface,
operate the end of arm tooling about the working surface as part of a surface treatment event comprising removing material from the working surface,
determine a change in a working surface characteristic using information provided by at least one of the first or second sensors, and
facilitate adjustment of the operation of at least one of the end of arm tooling or the robotic arm in response to the change in the working surface characteristic.

2. The system of claim 1, further comprising a third sensor operable to sense an operational state of one or more components of the end of arm tooling.

3. The system of claim 1, further comprising a third sensor operable to sense an operational state of the at least one surface treatment tool.

4. The system of claim 1, wherein the force comprises a normal force exerted on the surface treatment tool by the working surface, a rotational force exerted on the surface treatment tool by the working surface, a torque exerted on the surface treatment tool by the working surface, a force parallel to the working surface exerted on the surface treatment tool by the working surface, a force of friction exerted on the surface treatment tool by the working surface, or a combination thereof.

5. The system of claim 1, wherein the force comprises a vibrational force, and wherein the first sensor is operable to measure a magnitude of the vibrational force, a frequency of the vibrational force, a direction of the vibrational force, or a combination thereof.

6. The system of claim 1, wherein the force is indirectly measured by measuring one or more of electrical current passing through the surface treatment tool, a movement speed of the surface treatment tool, a pneumatic pressure head at the surface treatment tool wherein the surface treatment tool is pneumatic, a pneumatic flow through the surface treatment tool wherein the surface treatment tool is pneumatic, a temperature of the surface treatment tool, or a combination thereof.

7. The system of claim 1, wherein the surface treatment tool comprises at least one of an abrasive machining tool, a cutting tool, a drilling tool, a milling tool, an etching tool, a laser machining tool, a buffing tool, a particle-blasting tool, an abrading tool, a polishing tool, or a combination thereof.

8. The system of claim 1, wherein the surface treatment tool comprises a disc sander, an orbital sander, a random orbit sander, a belt sander, a drum sander, or an oscillating sander.

9. The system of claim 1, wherein the surface treatment tool comprises a moving abrasive head, and wherein the first sensor is operable to measure a movement speed of the abrasive head.

10. The system of claim 1, wherein, within an automated working mode, the control module facilitates automated operation of high level and low level aspects of operation of the robotic arm and the end of arm tooling.

11. The system of claim 1, wherein, within a teleoperated working mode, the control module facilitates teleoperation of a high level aspect of operation of at least one of the robotic arm or the end of arm tooling while facilitating automation of a low level aspect of the operation of at least one of the robotic arm or the end of arm tooling.

12. The system of claim 11, wherein, within an augmented teleoperated mode, the control module facilitates teleoperation of high level and low level aspects of operation of the robotic arm and the end of arm tooling, wherein the control module provides information associated with the change in the working surface characteristic to a human user.

13. The system of claim 1, wherein the second sensor comprises an imaging device operable to optically image the working surface to detect a property of the working surface.

14. The system of claim 13, wherein the imaging device is operable to distinguish wavelengths in the visible spectrum, the infrared spectrum, the ultraviolet spectrum, or a combination thereof.

15. The system of claim 1, wherein the second sensor comprises a temperature sensor, a hardness sensor, a roughness sensor, an electric conductivity sensor, an ultrasonic sensor, or a combination thereof.

16. The system of claim 1, further comprising an acoustic sensor operable to measure sound produced by operation of the surface treatment tool.

17. The system of claim 1, wherein the first and second sensors are part of a suite of sensors.

18. The system of claim 1, further comprising a clogging sensor operable to measure clogging of the surface treatment tool, or a wear sensor operable to measure wear of the surface treatment tool.

19. The system of claim 18, wherein the clogging sensor comprises an optical sensor operable to detect an optical change due to clogging in the surface treatment tool, a mass sensor operable to detect a change in mass due to clogging in the surface treatment tool, a temperature sensor operable to detect a change in temperature due to clogging in the surface treatment tool, an acoustic sensor operable to detect a change in sound due to clogging in the surface treatment tool, a force sensor operable to detect a change in a force associated with the surface treatment tool, or a combination thereof.

20. The system of claim 18, wherein the wear sensor comprises an optical sensor operable to detect an optical change due to wear in the surface treatment tool, a mass sensor operable to detect a change in mass due to wear in the surface treatment tool, a temperature sensor operable to detect a change in temperature due to wear in the surface treatment tool, an acoustic sensor operable to detect a change in sound due to wear in the surface treatment tool, a force sensor operable to detect a change in a force associated with the surface treatment tool, or a combination thereof.

21. The system of claim 18, wherein the instructions further cause the control module to signal a need for renewal of the surface treatment tool when clogging or wear reaches a predetermined threshold.

22. The system of claim 1, wherein the change in the working surface characteristic comprises a change in hardness, a change in roughness, a change in color, a change in infrared reflectivity, a change in ultraviolet reflectivity, a change in electric conductivity, a change in ultrasonic response, a change in a force associated with the end of arm tooling as engaged with the working surface, a change in sound produced by operation of the surface treatment tool, or a combination thereof.

23. The system of claim 1, wherein the working surface comprises at least one coating layer, and wherein the change in the working surface characteristic occurs when at least a portion of the at least one coating layer has been removed to expose a lower layer.

24. The system of claim 1, wherein adjusting the operation of the end of arm tooling comprises stopping the operation of the surface treatment tool, changing a speed of the surface treatment tool, changing a pressure of the surface treatment tool applied to the working surface, changing a center of pressure of the surface treatment tool on the working surface, changing an orientation of the surface treatment tool, or a combination thereof.

25. The system of claim 1, wherein adjusting the operation of the robotic arm comprises stopping the operation of the robotic arm, changing a speed of movement of the robotic arm, moving the robotic arm to lift the surface treatment tool off the working surface, moving the robotic arm to treat a different area of the working surface with the surface treatment tool, moving the robotic arm to change a pressure of the surface treatment tool applied to the working surface, moving the robotic arm to change a center of pressure of the surface treatment tool on the working surface, moving the robotic arm to change an orientation of the surface treatment tool, or a combination thereof.

26. The system of claim 1, wherein the control module comprises a machine learning module facilitating determination of the change in the working surface characteristic and adjustment of the operation of at least one of the end of arm tooling or the robotic arm, wherein the machine learning module is trained using a set of inputs comprising the information provided by at least one of the first or second sensors.

27. The system of claim 26, wherein the set of inputs further comprises example teleoperation of at least one of the end of arm tooling or the robotic arm by a human user.

28. The system of claim 26, wherein the set of inputs further comprises an identification of a material of the working surface, an identification of a coating material on the working surface, an identification of an abrasive medium on the surface treatment tool, an initial condition of the working surface provided by at least one of the first or second sensors, or a combination thereof.

29. The system of claim 26, wherein the machine learning module further comprises a library of legacy information comprising properties of the working surface, properties of other known surfaces, sensor measurements measured by at least one of the first or second sensors from the working surface, sensor measurements previously measured by at least one of the first or second sensors of other surfaces, sensor measurements recorded by a sensor of another system, properties of the end of arm tooling, properties of the surface treatment tool, properties of an abrasive medium on the surface treatment tool, or a combination thereof.

30. A method for automating the selective treatment of a working surface of a substrate, the method comprising:
identifying a working surface of a substrate for surface treatment;
identifying the nature of the surface treatment to be carried out on the substrate;
deploying a robotic system to initiate a surface treatment event, the robotic system comprising a robotic arm supporting end of arm tooling supporting at least one surface treatment tool operable to remove material from the working surface, the robotic system further comprising a first sensor and a second sensor operable to sense at least one aspect of, and to provide information associated with a surface treatment event;
removing material from the working surface using the surface treatment tool;
measuring a force associated with the end of arm tooling as engaged with the working surface using the first sensor;
measuring a property of the working surface using the second sensor;
providing information associated with the surface treatment event using at least one of the first or second sensors;
determining a change in a working surface characteristic using the information; and
adjusting operation of at least one of the end of arm tooling or the robotic arm in response to the change in the working surface characteristic.

31. The method of claim 30, wherein the step of identifying the type of surface treatment to be carried out on the substrate comprises identifying the material to be removed from the working surface of the substrate.

32. The method of claim 31, wherein the material to be removed comprises one or more coating layers on the working surface.

33. The method of claim 32, wherein the one or more coating layers comprise paint, primer, powder coat, ceramic, metal, or a combination thereof.

34. The method of claim 30, wherein the step of identifying the type of surface treatment to be carried out on the substrate comprises identifying a desired surface texture.

35. The method of claim 34, wherein the desired surface texture is a rough surface prepared for painting.

36. The method of claim 34, wherein the desired surface texture is a smooth surface finish.

37. The method of claim 30, wherein the substrate comprises an aircraft component, an automotive component, or a watercraft component.

38. The method of claim 30, wherein the robotic system further comprises an additional sensor operable to sense an operational state of one or more components of the end of arm tooling, and wherein the method further comprises measuring an operational state of one or more components of the end of arm tooling using the additional sensor.

39. The method of claim 30, wherein the robotic system further comprises an additional sensor operable to sense an operational state of the at least one surface treatment tool, and wherein the method further comprises measuring an operational state of the at least one surface treatment tool.

40. The method of claim 30, wherein the force comprises a normal force exerted on the surface treatment tool by the working surface, a rotational force exerted on the surface treatment tool by the working surface, a torque exerted on the surface treatment tool by the working surface, a force parallel to the working surface exerted on the surface treatment tool by the working surface, a force of friction exerted on the surface treatment tool by the working surface, or a combination thereof.

41. The method of claim 30, wherein the force measured by the force sensor comprises a vibrational force, and wherein the first sensor is operable to measure a magnitude of the vibrational force, a frequency of the vibrational force, a direction of the vibrational force, or a combination thereof.

42. The method of claim 30, wherein the force is measured indirectly by measuring one or more of electrical current passing through the surface treatment tool, a movement speed of the surface treatment tool, a pneumatic pressure head at the surface treatment tool wherein the surface treatment tool is pneumatic, a pneumatic flow through the surface treatment tool wherein the surface treatment tool is pneumatic, a temperature of the surface treatment tool, or a combination thereof.

43. The method of claim 30, wherein the surface treatment tool comprises at least one of an abrasive machining tool, a cutting tool, a drilling tool, a milling tool, an etching tool, a laser machining tool, a buffing tool, a particle-blasting tool, an abrading tool, a polishing tool, or a combination thereof.

44. The method of claim 30, wherein the surface treatment tool comprises a disc sander, an orbital sander, a random orbit sander, a belt sander, a drum sander, or an oscillating sander.

45. The method of claim 30, wherein the surface treatment tool comprises a moving abrasive head, and wherein the first sensor is operable to measure a movement speed of the abrasive head.

46. The method of claim 30, wherein the robotic system further comprises a control module operable to control the robotic arm and the end of arm tooling and the sensing fiduciary, the control module comprising at least one processor operable with one or more memory devices, and instructions that, when executed by the one or more processors, cause the control module to facilitate adjustment of operation of at least one of the end of arm tooling or the robotic arm in response to the change in the working surface characteristic.

47. The method of claim 46, wherein, within an automated working mode, the control module facilitates automated operation of high level and low level aspects of operation the robotic arm and the end of arm tooling.

48. The method of claim 46, wherein, within a teleoperated working mode, the control module facilitates teleoperation of a high level aspect of operation of at least one of the robotic arm or the end of arm tooling while facilitating automation of a low level aspect of the operation of at least one of the robotic arm or the end of arm tooling.

49. The method of claim 46, wherein, within an augmented teleoperated mode, the control module facilitates teleoperation of high level and low level aspects of operation of the robotic arm and the end of arm tooling, wherein the control module provides information associated with the change in the working surface characteristic to a human user.

50. The method of claim 30, wherein the second sensor comprises an imaging device operable to optically image the working surface, and wherein the property measured by the surface property sensor is an optical property.

51. The method of claim 50, wherein the imaging device is operable to distinguish wavelengths in the visible spectrum, the infrared spectrum, the ultraviolet spectrum, or a combination thereof.

52. The method of claim 30, wherein the second sensor comprises a temperature sensor, a hardness sensor, a roughness sensor, an electric conductivity sensor, an ultrasonic sensor, or a combination thereof.

53. The method of claim 30, wherein the robotic system further comprises an acoustic sensor operable to measure sound produced by operation of the surface treatment tool, and wherein the method further comprises measuring the sound produced by operation of the surface treatment tool using the acoustic sensor.

54. The method of claim 30, wherein the robotic system comprises a suite of sensors.

55. The method of claim 30, wherein the robotic system further comprises a clogging sensor operable to measure clogging of the surface treatment tool, or a wear sensor operable to measure wear of the surface treatment tool.

56. The method of claim 55, wherein the clogging sensor comprises an optical sensor operable to detect an optical change due to clogging in the surface treatment tool, a mass sensor operable to detect a change in mass due to clogging in the surface treatment tool, a temperature sensor operable to detect a change in temperature due to clogging in the surface treatment tool, an acoustic sensor operable to detect a change in sound due to clogging in the surface treatment tool, a force sensor operable to detect a change in a force associated with the surface treatment tool, or a combination thereof.

57. The method of claim 55, wherein the wear sensor comprises an optical sensor operable to detect an optical change due to wear in the surface treatment tool, a mass sensor operable to detect a change in mass due to wear in the surface treatment tool, a temperature sensor operable to detect a change in temperature due to wear in the surface treatment tool, an acoustic sensor operable to detect a change in sound due to wear in the surface treatment tool, a force sensor operable to detect a change in a force associated with the surface treatment tool, or a combination thereof.

58. The method of claim 55, further comprising signaling a need for renewal of the surface treatment tool when clogging or wear reaches a predetermined threshold.

59. The method of claim 30, wherein the change in the working surface characteristic comprises a change in hardness, a change in roughness, a change in color, a change in infrared reflectivity, a change in ultraviolet reflectivity, a change in electric conductivity, a change in ultrasonic response, a change in a force between the end of arm tooling and the working surface, a change in sound produced by operation of the end of arm tooling, or a combination thereof.

60. The method of claim 30, wherein the working surface comprises at least one coating layer, and wherein the change in the working surface characteristic occurs when at least a portion of the at least one coating layer has been removed to expose a lower layer.

61. The method of claim 30, wherein adjusting the operation of the end of arm tooling comprises stopping the operation of the surface treatment tool, changing a speed of the surface treatment tool, changing a pressure of the surface treatment tool applied to the working surface, changing a center of pressure of the surface treatment tool on the working surface, changing an orientation of the surface treatment tool, or a combination thereof.

62. The method of claim 30, wherein adjusting the operation of the robotic arm comprises stopping the operation of the robotic arm, changing a speed of movement of the robotic arm, moving the robotic arm to lift the surface treatment tool off the working surface, moving the robotic arm to treat a different area of the working surface with the surface treatment tool, moving the robotic arm to change a pressure of the surface treatment tool applied to the working surface, moving the robotic arm to change a center of pressure of the surface treatment tool on the working surface, moving the robotic arm to change an orientation of the surface treatment tool, or a combination thereof.

63. The method of claim 30, further comprising using a machine learning module to facilitate determination of the change in the working surface characteristic and adjustment of the operation of the end of arm tooling or the robotic arm, wherein the machine learning module is trained using a set of inputs comprising the information provided by at least one of the first or second sensors.

64. The method of claim 63, wherein the set of inputs further comprises example teleoperation of at least one of the end of arm tooling or the robotic arm by a human user.

65. The method of claim 63, wherein the set of inputs further comprises an identification of a material of the working surface, an identification of a coating material on the working surface, an identification of an abrasive medium on the surface treatment tool, an initial condition of the working surface provided by at least one of the first or second sensors, or a combination thereof.

66. The method of claim 63, wherein the machine learning module further comprises a library of legacy information comprising properties of the working surface, properties of other known surfaces, sensor measurements measured by at least one of the first or second sensors from the working surface, sensor measurements previously measured by at least one of the first or second sensors of other surfaces, sensor measurements recorded by a sensor of another system, properties of the end of arm tooling, properties of the surface treatment tool, properties of an abrasive medium on the surface treatment tool, or a combination thereof.

67. A system for automatic treatment of a working surface of a substrate, comprising:
a robotic arm;
end of arm tooling supported on the robotic arm, and operable with at least one surface treatment tool operable to remove material from the working surface;
a sensor operable to sense at least one aspect of, and to provide information associated with, a surface treatment event;
a control module operable to control the robotic arm and the end of arm tooling and the sensor, the control module comprising one or more processors operable with one or more memory devices, the control module further comprising a machine learning module, and instructions that, when executed by the one or more processors, cause the system to:
detect the presence of the working surface,
operate the end of arm tooling about the working surface as part of a surface treatment event comprising removing material from the working surface,
input the information provided by the sensor into the machine learning module,
using the machine learning module, facilitate determination of a change in a working surface characteristic using the information provided by the sensor, and
facilitate adjustment of the operation of at least one of the end of arm tooling or the robotic arm in response to the change in the working surface characteristic.

68. The system of claim 67, wherein the machine learning module is trained using a set of inputs comprising the information provided by the sensor.

69. The system of claim 68, wherein the sensor is part of a suite of sensors and wherein the set of inputs further comprises information provided by the suite of sensors.

70. The system of claim 68, wherein the set of inputs further comprises example teleoperation of at least one of the end of arm tooling or the robotic arm by a human user.

71. The system of claim 68, wherein the set of inputs further comprises an identification of a material of the working surface, an identification of a coating material on the working surface, an identification of an abrasive medium on the surface treatment tool, an initial condition of the working surface provided by the sensor, or a combination thereof.

72. The system of claim 68, wherein the machine learning module further comprises a library of legacy information comprising properties of the working surface, properties of other known surfaces, sensor measurements measured by the sensor from the working surface, sensor measurements previously measured by the sensor of other surfaces, sensor measurements recorded by a sensor of another system, properties of the end of arm tooling, properties of the surface treatment tool, properties of an abrasive medium on the surface treatment tool, or a combination thereof.
